(19) United States
(12) Patent Application Publication
(10) Pub. No.: US 2025/0142567 A1
(43) Pub. Date: May 1, 2025

(54) SINGLE-DCI MULTI-TRP BASED PDSCH RECEPTION WITH UNIFIED TCI FRAMEWORK

(71) Applicant: LENOVO (BEIJING) LIMITED, Beijing (CN)

(72) Inventors: Bingchao LIU, Beijing (CN); Chenxi ZHU, Fairfax, VA (US); Wei LING, Beijing (CN); Lingling XIAO, Beijing (CN); Yi ZHANG, Beijing (CN)

(21) Appl. No.: 18/837,092

(22) PCT Filed: Apr. 8, 2022
(86) PCT No.: PCT/CN2022/085758

§ 371 Date: Aug. 8, 2024

(51) Int. Cl. H04W 72/1273; H04B 7/06; H04W 72/231; H04W 76/20

(52) U.S. Cl. CPC H04W 72/1273; H04B 7/06968; H04W 72/231; H04W 76/20

(57) ABSTRACT

Methods and apparatuses for PDSCH reception in single-DCI multi-TRP scenario with unified TCI framework are disclosed. In one embodiment, a UE comprises a transceiver; and a processor coupled to the transceiver, wherein the processor is configured to receive, via the transceiver, a medium access control (MAC) control element (CE) activating at least one Transmission Configuration Indication (TCI) codepoint with two downlink (DL) or joint TCI states; receive, via the transceiver, a downlink control information (DCI) indicating one TCI codepoint being activated with two DL or joint TCI states if multiple TCI codepoints are activated with DL or joint TCI states; and determine one or two DL TCI states for reception of PDSCH scheduled by a scheduling DCI.

### FIELD

The subject matter disclosed herein generally relates to wireless communications, and more particularly relates to methods and apparatuses for PDSCH reception in single-DCI multi-TRP scenario with unified TCI framework.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Transmitter (TX), Receiver (RX), transmission reception point (TRP), Physical Downlink Shared Channel (PDSCH), Physical Downlink Control Channel (PDCCH), single frequency network (SFN), Downlink Control Information (DCI), Transmission Configuration Indicator (TCI), Physical Uplink Control Channel (PUCCH), Physical Uplink Shared Channel (PUSCH), component carrier (CC), control resource set (CORESET), quasi-colocation (QCL), Demodulation Reference Signal (DMRS), Channel State Information Reference Signal (CSI-RS), band width part (BWP), Medium Access Control (MAC), MAC control element (MAC CE), Code Division Multiplexing (CDM), transport block (TB), Space Division Multiplexing (SDM), Time Division Multiplexing (TDM), Frequency Division Multiplexing (FDM), Redundancy Version (RV), Time domain resource allocation (TDRA), Control Channel Element (CCE), resource block (RB), UE-specific search space (USS), common search space (CSS), Physical Resource Block (PRB), Sounding Reference Signal (SRS), reference signal (RS).

Multi-TRP based DL operation was introduced in NR Release 16 by means of multi-DCI based multi-TRP PDSCH transmission as well as single-DCI based multi-TRP PDSCH operation. Furthermore, single frequency network (SFN) based PDCCH and PDSCH transmissions were specified in NR Release 17 to improve the reliability of PDCCH and PDSCH for high speed train scenario.

All multi-TRP based DL transmission schemes in NR Release 16 and NR Release 17 are based on TCI framework specified in NR Release 15. For example, the TCI state for PDSCH reception is directly indicated by PDCCH carrying DCI scheduling the PDSCH.

In order to reduce the beam indication overhead, unified TCI framework was specified in NR Release 17 for single-TRP operation. A unified TCI state is shared for part of PDCCH and PDSCH in a cell. However, only single-TRP scenario is supported with unified TCI framework in NR Release 17.

This disclosure targets supporting single-DCI multi-TRP based PDSCH reception with unified TCI framework.

### BRIEF SUMMARY

Methods and apparatuses for PDSCH reception in single-DCI multi-TRP scenario with unified TCI framework are disclosed.

In one embodiment, a UE comprises a transceiver; and a processor coupled to the transceiver, wherein the processor is configured to receive, via the transceiver, a medium access control (MAC) control element (CE) activating at least one Transmission Configuration Indication (TCI) codepoint with two downlink (DL) or joint TCI states; receive, via the transceiver, a downlink control information (DCI) indicating one TCI codepoint being activated with two DL or joint TCI states if multiple TCI codepoints are activated with DL or joint TCI states; and determine one or two DL TCI states for reception of PDSCH scheduled by a scheduling DCI.

In one embodiment, the processor is configured to determine, for reception of the scheduled PDSCH, one of or both a first TCI state and a second TCI state of the two DL or joint TCI states activated to the only one activated TCI codepoint or the indicated one TCI codepoint.

In a first implementation, when a higher layer parameter sfnSchemePdsch is set to ‘sfnSchemeA’ or ‘sfnSchemeB’, both the first TCI state and the second TCI state are applied to the reception of the scheduled PDSCH; when a higher layer parameter repetitionScheme is set to ‘fdmSchemeA’ and ‘antenna port(s)’ field in the scheduling DCI indicates DMRS ports within one CDM group, the first TCI state is applied to a first PRB set allocated to the scheduled PDSCH and the second TCI state is applied to a second PRB set allocated to the scheduled PDSCH; when the higher layer parameter repetitionScheme is set to ‘fdmSchemeB’ and ‘antenna port(s)’ field in the scheduling DCI indicates DMRS ports within one CDM group, the first TCI state is applied to a first PRB set allocated to a first scheduled PDSCH transmission occasion and the second TCI state is applied to a second PRB set allocated to the second scheduled PDSCH transmission occasion; when the higher layer parameter repetitionScheme is set to ‘tdmSchemeA’ and ‘antenna port(s)’ field in the scheduling DCI indicates DMRS ports within one CDM group, the first TCI state is applied to a first scheduled PDSCH transmission occasion and the second TCI state is applied to a second scheduled PDSCH transmission occasion; when TDRA field in the scheduling DCI indicates an entry which contains repetitionNumber in PDSCH-TimeDomainResourceAllocation and ‘antenna port(s)’ field in the scheduling DCI indicates DMRS ports within one CDM group, if repetitionNumber=2, the first TCI state is applied to a first PDSCH transmission occasion and the second TCI state is applied to a second PDSCH transmission occasion, if repetitionNumber>2 and cyclicMapping is configured, the first and second TCI states are applied to the first and second PDSCH transmission occasions, respectively, and the same TCI mapping pattern continues to the remaining PDSCH transmission occasions, and if repetitionNumber>2 and sequenticalMapping is configured, the first TCI state is applied to the first and second PDSCH transmission occasions, and the second TCI state is applied to the third and fourth PDSCH transmission occasions, and the same TCI mapping pattern continues to the remaining PDSCH transmission occasions; and when the higher layer parameter sfnSchemePdsch is not configured or the higher layer parameter repetitionScheme is set to ‘fdmSchemeA’ or ‘fdmSchemeB’ or ‘tdmSchemeA’ and ‘antenna port(s)’ field in the scheduling DCI indicates DMRS ports within two CDM groups, the DMRS ports within a first CDM group are QCLed with the DL-RSs of the first TCI state, and the DMRS ports within a second CDM group are QCLed with the DL-RSs of the second TCI state.

In a second implementation, in the condition that one PDSCH is scheduled by the scheduling DCI carried in PDCCH associated with a first CORESET that is CORESET with index 0 or CORESET other than CORESET with index 0 associated with only CSS other than Type3-PDCCH CSS set, the same TCI state or QCL assumption as that used for reception of the PDCCH from the first CORESET is applied to the reception of PDSCH scheduled by the scheduling DCI carried in the PDCCH from the first CORESET, or when a higher layer parameter is configured for the first CORESET to indicate one of or both the first TCI state and the second TCI state, the indicated TCI state(s) by the configured higher layer parameter are applied to the reception of PDSCH scheduled by the scheduling DCI carried in PDCCH from the first CORESET, when the TCI state(s) for the first CORESET is activated by a second MAC CE, the first TCI state activated by the second MAC CE is applied to the reception of PDSCH scheduled by the scheduling DCI carried in the PDCCH from the first CORESET, and when the QCL assumption for the first CORESET is determined by SSB obtained from the latest RACH procedure, the determined SSB is applied to the reception of PDSCH scheduled by the scheduling DCI carried in the PDCCH from the first CORESET.

In a third implementation, in the condition that one PDSCH is scheduled by the scheduling DCI carried in PDCCH associated with a second CORESET that is CORESET associated with both USS and/or Type3-PDCCH CSS sets and CSS other than Type3-PDCCH CSS sets, the same TCI state or QCL assumption as that used for reception of PDCCH from the second CORESET is applied to the reception of PDSCH scheduled by the scheduling DCI carried in the PDCCH from the second CORESET, or when a higher layer parameter is configured for the second CORESET to indicate one of or both the first TCI state and the second TCI state, the TCI state(s) indicated by the configured higher layer parameter are applied to the reception of PDSCH scheduled by the scheduling DCI carried in PDCCH from the second CORESET, or the TCI state(s) indicated by the configured higher layer parameter are applied to the reception of PDSCH scheduled by the scheduling DCI carried in the PDCCH associated with the CSS other than Type3-PDCCH CSS sets from the second CORESET, and the first TCI state is applied to the reception of PDSCH scheduled by the scheduling DCI carried in the PDCCH associated with the USS and/or Type3-PDCCH CCS sets from the second CORESET, and when the TCI state(s) for the second CORESET are activated by a second MAC CE, the TCI state(s) activated by the second MAC CE are applied to the reception of PDSCH scheduled by the scheduling DCI carried in the PDCCH from the second CORESET, or the TCI state(s) activated by the second MAC CE are applied to the reception of PDSCH scheduled by the scheduling DCI carried in the PDCCH associated with the CSS other than Type3-PDCCH CSS sets from the second CORESET, and the first TCI state is applied to the reception of PDSCH scheduled by the scheduling DCI carried in the PDCCH associated with the USS and/or Type3-PDCCH CCS sets from the second CORESET, or the TCI state(s) activated by the second MAC CE are applied to the reception of PDSCH scheduled by the scheduling DCI carried in the PDCCH associated with the CSS other than Type3-PDCCH CSS sets from the second CORESET, and the activated TCI state with the lowest index is applied to the reception of PDSCH scheduled by the scheduling DCI carried in the PDCCH associated with the USS and/or Type3-PDCCH CCS sets from the second CORESET.

In some embodiment, the processor is configured to determine a default TCI state for the reception of PDSCH scheduled by the scheduling DCI carried in PDCCH from a third CORESET which is a CORESET whose TCI state is activated by a second MAC CE or whose QCL assumption is determined by SSB obtained in the latest RACH procedure, when only one DL TCI state is indicated for DL reception. In particular, the default TCI state is one of: the TCI state activated by the second MAC CE for the third CORESET or the QCL assumption determined for the third CORESET, the indicated one DL TCI state, the activated TCI state with the lowest index, and if the third CORESET is associated with both SS USS and/or Type3-PDCCH CSS sets and CSS other than Type3-PDCCH CSS sets, the TCI state activated by the second MAC CE for the third CORESET or the QCL assumption determined for the third CORESET for the reception of PDSCH scheduled by the scheduling DCI carried in PDCCH associated with CSS other than Type3-PDCCH CSS set from the third CORESET, and the indicated one TCI state for the reception of PDSCH scheduled by the scheduling DCI carried in the PDCCH associated with USS and/or Type3-PDCCH CSS set from the third CORESET.

In another embodiment, a method at a UE comprises receiving a medium access control (MAC) control element (CE) activating at least one Transmission Configuration Indication (TCI) codepoint with two downlink (DL) or joint TCI states; receiving a downlink control information (DCI) indicating one TCI codepoint being activated with two DL or joint TCI states if multiple TCI codepoints are activated with DL or joint TCI states; and determining one or two DL TCI states for reception of PDSCH scheduled by a scheduling DCI

In still another embodiment, a base unit comprises a transceiver; and a processor coupled to the transceiver, wherein the processor is configured to transmit, via the transceiver, a medium access control (MAC) control element (CE) activating at least one Transmission Configuration Indication (TCI) codepoint with two downlink (DL) or joint TCI states; transmit, via the transceiver, a downlink control information (DCI) indicating one TCI codepoint being activated with two DL or joint TCI states if multiple TCI codepoints are activated with DL or joint TCI states; and determine one or two DL TCI state for transmission of PDSCH scheduled by a scheduling DCI.

In yet another embodiment, a method of a base unit comprises transmitting a medium access control (MAC) control element (CE) activating at least one Transmission Configuration Indication (TCI) codepoint with two downlink (DL) or joint TCI states; transmitting a downlink control information (DCI) indicating one TCI codepoint being activated with two DL or joint TCI states if multiple TCI codepoints are activated with DL or joint TCI states; and determining one or two DL TCI state for transmission of PDSCH scheduled by a scheduling DCI

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates an example for SFN scheme A or B;

FIG. 2(a) illustrates an example for FDM scheme 2a;

FIG. 2(b) illustrates an example for FDM scheme 2b;

FIG. 3 illustrates an example for TDM scheme 3;

FIG. 4 illustrates an example for TDM scheme 4 in which repetitionNumber is equal to 2;

FIG. 5 illustrates an example for TDM scheme 4 in which repetitionNumber is equal to 8 and cyclicMapping is enabled;

FIG. 6 illustrates an example for TDM scheme 4 in which repetitionNumber is equal to 8 and sequenticalMapping is enabled;

FIG. 7 illustrates an example for SDM scheme 1a;

FIG. 8 is a schematic flow chart diagram illustrating an embodiment of a method;

FIG. 9 is a schematic flow chart diagram illustrating an embodiment of another method; and

FIG. 10 is a schematic block diagram illustrating apparatuses according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

For multi-DCI based multi-TRP, each TRP may independently send DCI scheduling PDSCH transmission from the corresponding TRP. A UE may receive, from different TRPs in a slot, multiple DCIs scheduling multiple fully-overlapped or partial-overlapped or non-overlapped PDSCH transmissions in another slot. A RRC parameter coresetPoolIndex with value 0 or 1 is configured for a CORESET for TRP differential. For example, all CORESETs configured for TRP #1 is configured with coresetPoolIndex with value 0, and all the CORESET, configured for TRP #2 is configured with coresetPoolIndex with value 1.

For single-DCI based multi-TRP, one TRP may send a DCI scheduling one or multiple PDSCH transmissions from one or multiple TRPs. Only one DCI can be transmitted in one slot from a TRP.

In NR Release 17 unified TCI framework, joint DL/UL TCI or separate DL/UL TCI can be configured for a cell by RRC signaling.

When separate DL/UL TCI is configured, the DL TCI state for DL reception and UL TCI state for UL transmission are separately indicated. For UL TCI state, the source reference signal in the UL TCI provides a reference for determining UL TX spatial filter at least for dynamic-grant or configured-grant based PUSCH transmission and all of dedicated PUCCH resources, which are the PUCCH resources in RRC-connected mode, in a CC. For DL TCI state, the source reference signal(s) (one source reference signal is contained if only the higher layer parameter qcl-Type1 is configured, and two source reference signals are contained if both the higher layer parameter qcl-Type1 and the higher layer parameter qcl_Type2 are configured) in the DL TCI provides QCL information at least for UE-dedicated reception on PDCCH and the PDSCH receptions in a CC. Each CORESET is configured by a set time-frequency resource for PDCCH reception.

When joint DL/UL TCI is configured, both UL TCI state for UL transmission and DL TCI state for DL reception are determined by a single indicated joint DL/UL TCI state. When the joint DL/UL TCI state is configured, a joint TCI refers to at least a common source reference RS used for determining both the DL QCL information and the UL TX spatial filter. For example, the UL TX beam and the DL RX beam are both determined by the QCL-TypeD RS configured in the indicated joint DL/UL TCI state.

A brief introduction of the TCI state is provided as follows:

The UE can be configured with a list of up to M TCI-State configurations to decode PDSCH according to a detected PDCCH with DCI intended for the UE and the given serving cell, where M depends on the UE capability. The TCI-state is configured by the following RRC signaling:

The IE TCI-State associates one or two DL reference signals with a corresponding quasi-colocation (QCL) type.

TCI-State information element

| | |
|---|---|
| TCI-State ::= | SEQUENCE { |
| tci-StateId | TCI-StateId, |
| qcl-Type1 | QCL-Info, |
| qcl-Type2 | QCL-Info |

...
}

| | |
|---|---|
| QCL-Info ::= | SEQUENCE { |
| cell | ServCellIndex |
| bwp-Id | BWP-Id |
| referenceSignal | CHOICE { |
| csi-rs | NZP-CSI-RS-ResourceId, |
| ssb | SSB-Index |

},

| | |
|---|---|
| qcl-Type | ENUMERATED {typeA, typeB, typeC, typeD}, |

...
}

Each TCI-State contains parameters for configuring a quasi co-location (QCL) relationship between one or two downlink reference signals and the DMRS ports of the PDSCH, the DMRS port of PDCCH or the CSI-RS port(s) of a CSI-RS resource. The quasi co-location relationship is configured by the higher layer parameter qcl-Type1 for the first DL RS, and qcl-Type2 for the second DL RS (if configured). For the case of two DL RSs, the QCL types shall not be the same, regardless of whether the references are to the same DL RS or different DL RSs. The quasi co-location types corresponding to each DL RS are given by the higher layer parameter qcl-Type in QCL-Info and may take one of the following values:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}

The UE receives an activation command used to map up to 8 TCI states to the codepoints of the DCI field ‘Transmission Configuration Indication’ (TCI field) in one DL BWP of a serving cell for single-TRP scenario. When a UE supports two TCI states in a codepoint of the DCI field ‘Transmission Configuration Indication’ to determine different TX beams for UL transmission or to determine different DL beams for DL reception, the UE may receive an activation command, the activation command is used to map up to 8 combinations of one or two TCI states to the codepoints of the DCI field ‘Transmission Configuration Indication’, where the one or two TCI states are both used for UL TX beam determination or DL RX beam determination.

To support single-DCI multi-TRP based DL transmission, when separate DL/UL TCI is configured, the DL TCI state activation/deactivation MAC CE and/or UL TCI state activation/deactivation can map up to two DL TCI states and/or up to two UL TCI states to a TCI codepoint contained in DCI format 1_1 or 1_2. When joint DL/UL TCI is configured, the joint TCI state activation/deactivation MAC CE can map up to two joint DL/UL TCI states to a TCI codepoint contained in DCI format 1_1 or 1_2. The TCI codepoint that is mapped with at least one TCI state (DL TCI state, or UL TCI state or joint DL/UL TCI state) is referred to be activated, and the DL TCI state, or UL TCI state or joint DL/UL TCI state mapped to the codepoint is referred to be activated.

If a TCI codepoint is mapped with one UL TCI state and one DL TCI state, and the TCI codepoint is indicated by DCI format 1_1 or 1_2 or is the only TCI codepoint activated by DL or joint TCI state activation/deactivation MAC CE, the one UL TCI state shall be applied to all PUSCH, PUCCH and aperiodic SRS resources without configured TCI state, and the DL TCI state shall be applied to part of CORESETs and the PDSCH scheduled by DCI transmitted from the CORESET.

If a TCI codepoint is mapped with two DL or joint TCI states (e.g. first DL or joint TCI state and second DL or joint TCI state) and the TCI codepoint is indicated by DCI format 1_1 or 1_2 or is the only TCI codepoint activated by DL or joint TCI state activation/deactivation MAC CE, which one of the two DL or joint TCI states or both DL or joint TCI states (i.e. the first DL or joint TCI state, or the second DL or joint TCI state, or both the first DL or joint TCI state and the second DL or joint TCI state) are applied to PDSCH reception for different multi-TRP PDSCH schemes is discussed in this disclosure (especially in the first to the third embodiments).

In addition, if a TCI codepoint is mapped with one DL or joint TCI states and the TCI codepoint is indicated by DCI format 1_1 or 1_2 or is the only TCI codepoint activated by DL or joint TCI state activation/deactivation MAC CE, whether the indicated one DL or joint TCI state is applied to PDSCH reception is also discussed in this disclosure (especially in the fourth embodiment).

In the following description, to support single-DCI based multi-TRP DL transmission, it is assumed that at least one TCI codepoint is activated and mapped with one or two DL or joint TCI states and is referred to the activated or indicated TCI codepoint. The one TCI codepoint being activated with one or two DL or joint TCI states means that a DL or joint TCI state activation/deactivation MAC CE only activates one TCI codepoint, e.g. maps one or two DL or joint TCI states to the one TCI codepoint. The one TCI codepoint being indicated with one or two DL or joint TCI states means that a DL or joint TCI state activation/deactivation MAC CE activates two or multiple TCI codepoints, e.g. maps one or two DL or joint TCI states to at least one of the two or multiple TCI codepoints, while a DCI with format 1_1 or 1_2 indicates one TCI codepoint that is mapped with one or two DL or joint TCI states. If two DL or joint TCI states are mapped to (or activated to) the activated or indicated TCI codepoint, they can be referred to as activated or indicated two DL or joint TCI states, and are further described as “first TCI state” and “second TCI state”, where, the first TCI state refers to a first TCI state of the activated or indicated two DL or joint TCI states, and the second TCI state refers to a second TCI state of the activated or indicated two DL or joint TCI states, unless they are further limited. If one DL or joint TCI state is mapped to (or activated to) the activated or indicated TCI codepoint, it can be referred to as activated or indicated DL or joint TCI state, and is further described as “indicated TCI state”.

An example is described as follows:

It is assumed that the following TCI states are mapped to each TCI codepoint activated by the DL or joint TCI state activation/deactivation MAC CE:
TCI codepoint 000: UL-TCI-State #1 & UL-TCI-State #12;
TCI codepoint 001: UL-TCI-State #23;
TCI codepoint 010: UL-TCI-State #32;
TCI codepoint 011: UL-TCI-State #24 and DL-TCI-State #45 and DL-TCI-State #50;
TCI codepoint 100: UL-TCI-State #45 and DL-TCI-State #2;
TCI codepoint 101: UL-TCI-State #55 & UL-TCI-State #60 and DL-TCI-State #32 & DL-TCI-State #65;
TCI codepoint 110: DL-TCI-State #64 & DLo-TCI-State #85;
TCI codepoint 111: DL-TCI-State #120.

For example, when TCI codepoint 110 is activated, two DL TCI states, e.g., DL-TCI-State #64 and DL-TCI-State #85, are indicated as the DL TCI states (i.e. the first TCI state is DL-TCI-State #64, and the second TCI state is DL-TCI-State #85.

For another example, when TCI codepoint 111 is activated, one DL TCI state, e.g. DL-TCI-State #120, is indicated as the DL TCI state (i.e. the “indicated TCI state” is DLTCI-State #120).

In addition, among all activated DL TCI states, DL-TCI-State #2 (e.g. mapped to TCI codepoint 100) has the lowest DL-TCI-State-Id.

Before describing the detailed embodiments, PDSCH schemes are described. Different multi-TRP PDSCH schemes have been specified, as listed in Table 1.

TABLE 1

| Multi-TRP | | How to identify the corresponding |
|---|---|---|
| scheme | Description | scheme |
| SDM scheme | A single PDSCH transmission | RRC parameter sfnSchemePdsch is not |
| 1a | occasion is scheduled, and | configured or RRC parameter |
| | different layers of the PDSCH are | repetitionScheme is set to ‘fdmSchemeA’ or |
| | transmitted by different TRPs | ‘fdmSchemeB’ or ‘tdmSchemeA’, two TCI |
| | | states are indicated by the scheduling DCI |
| | | and the indicated DMRS ports are within |
| | | two CDM groups. |
| FDM scheme | A single PDSCH transmission | RRC parameter repetitionScheme is set to |
| 2a | occasion of a TB is scheduled, | ‘fdmSchemeA’, two TCI states are indicated |
| | while separate frequency domain | and the DMRS ports are within one CDM |
| | resources are used by different | groups. |
| | TRPs for transmission part of the | |
| | single PDSCH. | |
| FDM scheme | Two PDSCH transmission | RRC parameter repetitionScheme is set to |
| 2b | occasions corresponding to two | ‘fdmSchemeB’, two TCI states are indicated |
| | RVs of a TB are scheduled, while | and the DMRS ports are within one CDM |
| | separate frequency domain | groups. |
| | resources are used by different | |
| | TRPs for each PDSCH. Each | |
| | PDSCH is transmitted by a TRP | |
| | by using a separated set of | |
| | frequency domain resources. | |
| TDM scheme | Two PDSCH transmission | RRC parameter repetitionScheme is set to |
| 3 | occasions corresponding to two | ‘tdmSchemeA’, two TCI states are indicated |
| | RVs of a TB are scheduled, while | and the DMRS ports are within one CDM |
| | separated time domain resources | groups. |
| | within a same slot are used by | |
| | different TRPs for each PDSCH. | |
| | Each PDSCH is transmitted by a | |
| | TRP by using a separated set of | |
| | time domain resources | |
| TDM scheme | Two or more PDSCH | The TDRA field in DCI indicating an entry |
| 4 | transmission occasions | which contains repetitionNumber in |
| | corresponding to two RVs of a | PDSCH-TimeDomainResourceAllocation, |
| | TB are scheduled, different | two TCI states are indicated and DMRS |
| | PDSCH is transmitted in different | ports within are one CDM group. |
| | slots by different TRPs | |
| SFN scheme | A single PDSCH transmission | RRC parameter sfnSchemePdsch is set to |
| A | occasion is scheduled to be | ‘sfnSchemeA’, and two TCI states are |
| | transmitted by different TRPs | indicated by the scheduling DCI. |
| | with different beams on the same | |
| | set of time-frequency resources. | |
| SFN scheme | A single PDSCH transmission | RRC parameter sfnSchemePdsch is set to |
| B | occasion is scheduled to be | ‘sfnSchemeB’, and two TCI states are |
| | transmitted by different TRPs | indicated by the scheduling DCI. |
| | with different beams, and the | |
| | Doppler shift of the channel is | |
| | compensated for the scheduled | |
| | PDSCH by gNB. | |

One DCI with format 1_1 or 12 may schedule one or more PDSCH transmission occasions. Each PDSCH transmission occasion carries one or two transport blocks (TBs) on a set of frequency-time resources. In the scheduling DCI, the antenna port field indicates one or more DMRS antenna ports for PDSCH reception. The DMRS antenna ports are used for DL channel estimation. Different DMRS ports may be within different CDM groups. The DMRS ports within a CDM group are multiplexed by using different codes. A PDSCH transmission occasion can be transmitted by different PDSCH layers. The number of PDSCH layers is the same as the number of indicated DMRS ports, and each PDSCH layer corresponds to a DMRS port. In order to improve the transmission reliability, the information bits, i.e., TB, for transmission are coded by a channel coding. Different redundancy versions (RVs) are generated for a set of information bits, i.e., a TB, and each PDSCH transmission occasion carries a RV of one or two carried TBs. Incidentally, a PDSCH transmission occasion can be shortened as a PDSCH if appropriate, and different PDSCH transmission occasions can be shortened as different PDSCHs if appropriate.

For a UE, only one of FDM scheme 2a, FDM scheme 2b, TDM scheme 3, TDM scheme 4, SFN scheme A or SFN scheme B can be configured for the BWP of a cell. However, dynamic switching between above schemes and SDM scheme 1a can be supported for a UE.

Different from NR Release 15 TCI framework, in unified TCI framework, a same TCI state is used for the PDCCH and the PDSCH scheduled by the PDCCH when the CORESET for the PDCCH reception is determined to use the indicated TCI state in single TRP scenario. Different TCI states may be determined to be used for different CORESETs associated with different search space types. As a result, different TCI states may be used for different PDSCHs scheduled by PDCCH from different CORESETs associated with different search space types.

A UE can be configured with up to 4 BWPs in a cell. Up to 3 CORESETs can be configured in a BWP if the higher layer parameter coresetPoolIndex, which is used for TRP differential in multi-DCI based multi-TRP mode, is not configured in each CORESET or a same value of coresetPoolIndex is configured for all CORESETs. Each CORESET is consisted of a set of frequency-time resources for PDCCH reception. Each CORESET is associated with one or more search spaces. The UE shall monitor PDCCH per search space. A search space is a set of candidate control channels formed by CCEs (Control Channel Elements) at a given aggregation level, which the UE is supposed to decode, where a CCE is a number of RB (resource block) groups in a CORESET. The search space can be UE-specific search space (USS), which is a search space dedicated for a UE, or common search space (CSS), which is a search space for a group of UEs. The following types of CSS are supported:
Type0-PDCCH CSS set, Type0A-PDCCH CSS set, and Type0B-PDCCH CSS set: they are used to monitor system information. Different CSS types are used for different types of system information.
Type1-PDCCH CSS set and Type1A-PDCCH CSS set: they are used for random access procedure.
Type2-PDCCH CSS set and Type2A-PDCCH CSS set: they are used for paging.
Type3-PDCCH CSS set: it is used for group common PDCCH reception.
Type0-PDCCH CSS set, Type0A-PDCCH CSS set, Type0B-PDCCH CSS set, Type1-PDCCH CSS set, Type1A-PDCCH CSS set, Type2-PDCCH CSS set and Type2A-PDCCH CSS set are monitored by all the UEs in a cell. Type3-PDCCH CSS set is monitored by a group of UEs in a cell.

The group of UEs shall monitor a Type3-PDCCH CSS using a same beam which is usually the same as that used for monitoring USS. So, in this disclosure, Type3-PDCCH CSS set and USS are classified in one SS category (e.g. SS category #1), while CSS other than Type3-PDCCH CSS sets (i.e. Type0-PDCCH CSS set, Type0A-PDCCH CSS set, Type0B-PDCCH CSS set, Type1-PDCCH CSS set, Type1A-PDCCH CSS set, Type2-PDCCH CSS set and Type2A-PDCCH CSS set) are classified in another SS category (e.g. SS category #2).

As mentioned above, there are three CORESETs: for example, CORESET #0 (CORESET with index 0), CORESET #1 (CORESET with index 1) and CORESET #2 (CORESET with index 2). The UE can only monitor CORESET #0 during initial access procedure to obtain system information. CORESET #1 and CORESET #2 can be referred to as CORESET other than CORESET #0 (CORESET with index other than 0). There are two SS categories: SS category #1 (Type3-PDCCH CSS set and USS) and SS category #2 (CSS other than Type3-PDCCH CSS sets: Type0-PDCCH CSS set, Type0A-PDCCH CSS set, Type0B-PDCCH CSS set, Type1-PDCCH CSS set, Type1A-PDCCH CSS set, Type2-PDCCH CSS set and Type2A-PDCCH CSS set).

CORESET other than CORESET #0 can be associated with USS and/or CSS. For example, CORESET other than CORESET #0 associated with SS category #1 means that CORESET other than CORESET #0 associated with Type3-PDCCH CSS set and/or USS. CORESET other than CORESET #0 associated with SS category #2 means that CORESET other than CORESET #0 associated with at least one of CSS other than Type3-PDCCH CSS sets (i.e. at least one Type0-PDCCH CSS set, Type0A-PDCCH CSS set, Type0B-PDCCH CSS set, Type1-PDCCH CSS set, Type1A-PDCCH CSS set, Type2-PDCCH CSS set and Type2A-PDCCH CSS set).

If a DL TCI state (or joint TCI state) is determined to be applied to PDSCH reception (or reception of PDSCH), it means that the UE assumes that the DMRS port(s) of the PDSCH are QCLed with the DL-RS(s) of the DL or joint TCI state.

A first embodiment is related to the determination of TCI state(s) for reception of PDSCH scheduled by DCI carried in PDCCH from CORESET associated with a search space only in SS category #1 (i.e. USS and/or Type3-PDCCH CSS sets) in a CC, when two DL or joint TCI states (e.g. first TCI state and second TCI state) are indicated for DL reception (e.g. as described in above example, when TCI codepoint 110 is activated, two DL TCI states, e.g., DL-TCI-State #64 and DL-TCI-State #85, are indicated as the DL TCI states: the first TCI state is DL-TCI-State #64 and the second TCI state is DL-TCI-State #85).

Case 11: when SFN scheme is configured in a BWP of a cell.

Case 111: when SFN scheme A is configured (that is, RRC parameter sfnSchemePdsch is set to ‘sfnSchemeA’), both the first TCI state and the second TCI state are applied to PDSCH reception.

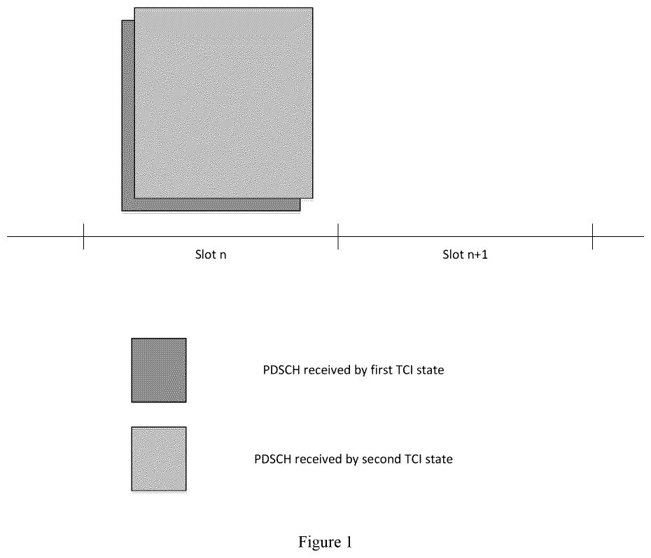

An example of case 111 (for SFN scheme A) is illustrated in FIG. 1. A single PDSCH is scheduled to be transmitted by two TRPs (e.g. TRP #1 and TRP #2) on a same set of frequency-time resources. The UE receives the PDSCH by using the first TCI state and the second TCI state. That is, the UE assumes that the DMRS port(s) of the PDSCH are QCLed with the DL-RSs of the first TCI state and the second TCI state.

Case 112: when SFN scheme B is configured (that is, RRC parameter sfnSchemePdsch is set to ‘sfnSchemeB’), both the first TCI state and the second TCI state are applied to PDSCH reception. The UE assumes that the DMRS port(s) of the PDSCH are QCLed with the DL-RSs of the first TCI state and the second TCI state except for QCL parameters {Doppler shift, Doppler spread} of the second TCI state since the Doppler shift and Doppler spread are compensated by the gNB.

An example of case 112 (for SFN scheme B) is similar to case 111 (for SFN scheme A) shown in FIG. 1.

Case 12: when FDM scheme 2a is configured (i.e., RRC parameter repetitionScheme is set to ‘fdmSchemeA’) and the ‘antenna port(s)’ field in the scheduling DCI indicates DMRS ports within one CDM group.

The UE shall receive a single PDSCH by using two TCI states, wherein, each TCI state is associated to a different frequency domain resource allocation (i.e. two TCI states are associated, respectively, with non-overlapping two frequency domain resource allocations). The first TCI state is applied to the PDSCH within a first frequency domain resource allocation (e.g. a first set of PRBs), and the second TCI state is applied to the PDSCH within a second frequency domain resource allocation (e.g. a second set of PRBs). The first frequency domain resource allocation (e.g. a first set of PRBs) and the second frequency domain resource allocation (e.g. a second set of PRBs) are non-overlapped.

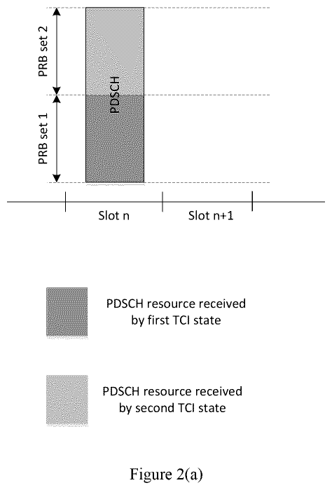

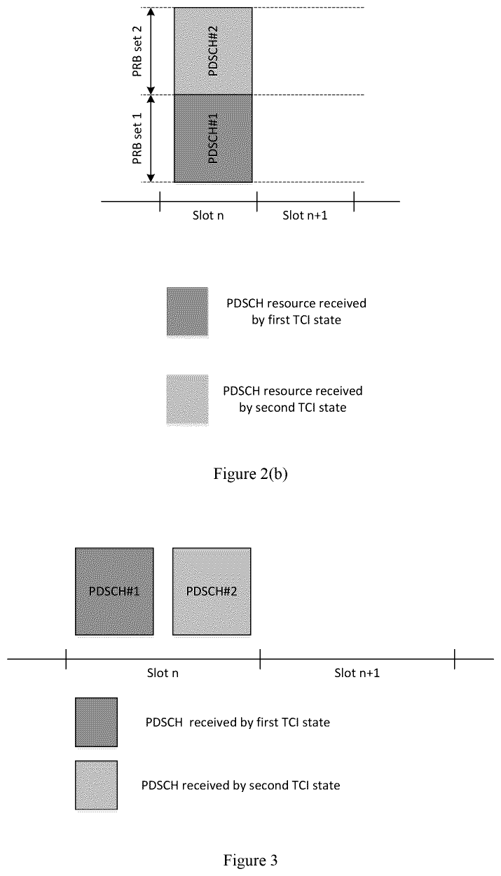

An example of case 12 (for FDM scheme 2a) is illustrated in FIG. 2(a), wherein a single PDSCH transmission occasion (shown as “PDSCH” in FIG. 2(a)) is scheduled to be transmitted by two TRPs (e.g. TRP #1 and TRP #2), where the PDSCH transmission occasion within a first set of PRBs are transmitted by TRP #1, and the PDSCH transmission occasion within a second set of PRBs are transmitted by TRP #2. So, the first TCI state is applied to the reception of the PDSCH transmission occasion within the first set of PRBs, and the second TCI state is applied to the reception of the PDSCH transmission occasion within the second set of PRBs.

Case 13: When FDM scheme 2b is configured (i.e., RRC parameter repetitionScheme is set to ‘fdmSchemeB’) and the ‘antenna port(s)’ field in the scheduling DCI indicates DMRS ports within one CDM group.

The UE shall receive two PDSCH transmission occasions (e.g. a first PDSCH transmission occasion and a second PDSCH transmission occasion) of the same TB by using two TCI states, wherein, each TCI state is associated to a different PDSCH transmission occasion. Two PDSCH transmission occasions are associated with different frequency domain resource allocations (i.e. with non-overlapping frequency domain resource allocations) (e.g. non-overlapping first set of PRBs and second set of PRBs). The first TCI state is applied to the reception of the first PDSCH transmission occasion, and the second TCI state is applied to the reception of the second PDSCH transmission occasion.

An example of case 13 (for FDM scheme 2b) is illustrated in FIG. 2(b), where two PDSCH transmission occasions (shown as “PDSCH #1” and “PDSCH #2” in FIG. 2(b)), that are associated, respectively, with a first set of PRBs and a second set of PRBs, are scheduled to be transmitted by two TRPs (e.g. TRP #1 and TRP #2), where PDSCH #1 associated with the first set of PRBs is transmitted by TRP #1, and PDSCH #2 associated with the second set of PRBs is transmitted by TRP #2. So, the first TCI state is applied to the reception of PDSCH #1 associated with the first set of PRBs, and the second TCI state is applied to the reception of PDSCH #2 associated with the second set of PRBs.

Case 14: when TDM scheme 3 is configured (i.e., RRC parameter repetitionScheme is set to ‘tdmSchemeA’) and the ‘antenna port(s)’ field in the scheduling DCI indicates DMRS ports within one CDM group.

The UE shall receive two PDSCH transmission occasions (e.g. a first PDSCH transmission occasion and a second PDSCH transmission occasion) of the same TB by using two TCI states, wherein, each TCI state is associated to a different PDSCH transmission occasion. Two PDSCH transmission occasions are associated with different time domain resource allocations (i.e. with non-overlapping time domain resource allocations) within a given slot. The first TCI state is applied to the reception of the first PDSCH transmission occasion, and the second TCI state is applied to the reception of the second PDSCH transmission occasion.

An example of case 14 (for TDM scheme 3) is illustrated in FIG. 3, where two PDSCH transmission occasions (shown as “PDSCH #1” and “PDSCH #2” in FIG. 3) associated with non-overlapping time domain resource allocations within slot n, are scheduled to be transmitted by two TRPs (e.g. TRP #1 and TRP #2), where PDSCH #1 is transmitted by TRP #1, and PDSCH #2 is transmitted by TRP #2. So, the first TCI state is applied to the reception of PDSCH #1, and the second TCI state is applied to the reception of PDSCH #2.

Case 15: When TDM scheme 4 is indicated by the scheduling DCI (i.e., the TDRA field in the scheduling DCI indicating an entry containing a parameter repetitionNumber equal to or larger than 2) and the ‘antenna port(s)’ field in the scheduling DCI indicates DMRS ports within one CDM group, the UE shall receive repetitionNumber PDSCH transmission occasions across the repetitionNumber consecutive slots.

Case 151: When repetitionNumber=2, the first TCI state is applied to the reception of the first PDSCH transmission occasion and the second TCI state is applied to the reception of the second PDSCH transmission occasion.

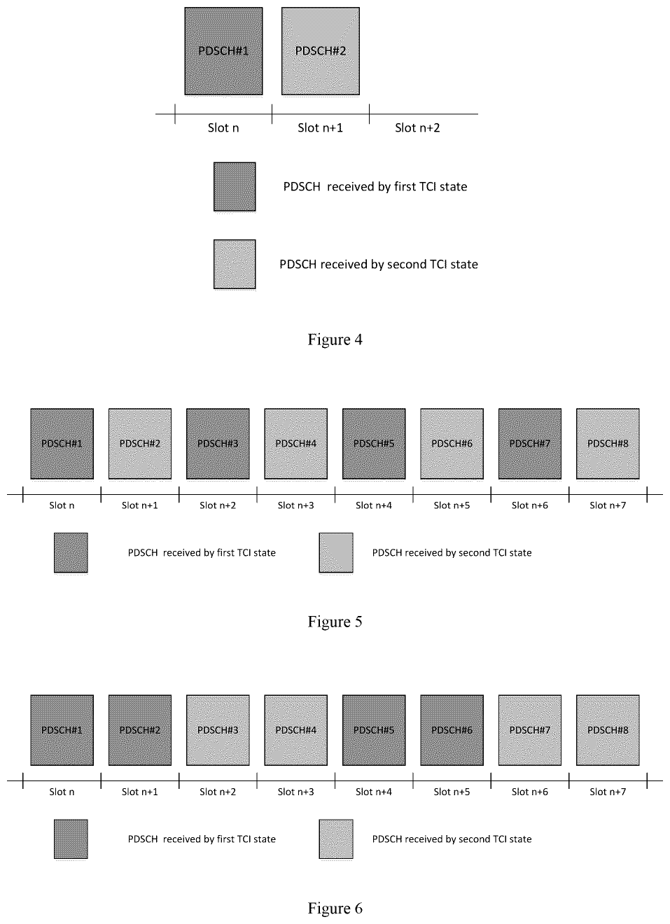

An example of case 151 is illustrated in FIG. 4. Two PDSCH transmission occasions (shown as “PDSCH #1” and “PDSCH #2” in FIG. 4) are scheduled, respectively, in slot n and slot n+1. The first TCI state and second TCI state are applied to the reception of the first PDSCH transmission occasion (i.e. “PDSCH #1”) and the second PDSCH transmission occasion (i.e. “PDSCH #2”), respectively.

Case 152: when repetitionNumber>2 (e.g. repetitionNumber=4 or 8) and RRC parameter cyclicMapping is configured, the first and second TCI states are applied to the reception of the first and second PDSCH transmission occasions, respectively, and the same TCI mapping pattern continues to the remaining PDSCH transmission occasions.

An example of case 152 is illustrated in FIG. 5. Eight (8) PDSCH transmission occasions (shown as “PDSCH #1”, “PDSCH #2”, “PDSCH #3”, “PDSCH #4”, “PDSCH #5”, “PDSCH #6”, “PDSCH #7”, “PDSCH #8” in FIG. 5) are scheduled, respectively, in slots n to n+7. The first TCI state and second TCI state are applied to the reception of the first PDSCH transmission occasion (i.e. “PDSCH #1”) and the second PDSCH transmission occasion (i.e. “PDSCH #2”), respectively. In addition, the first TCI state and second TCI state are applied to the reception of the third PDSCH transmission occasion (i.e. “PDSCH #3”) and the fourth PDSCH transmission occasion (i.e. “PDSCH #4”) respectively, the reception of the fifth PDSCH transmission occasion (i.e. “PDSCH #5”) and the sixth PDSCH transmission occasion (i.e. “PDSCH #6”) respectively, and the reception of the seventh PDSCH transmission occasion (i.e. “PDSCH #7”) and the eighth PDSCH transmission occasion (i.e. “PDSCH #8”) respectively.

Case 153: when repetitionNumber>2 (e.g. repetitionNumber=4 or 8) and RRC parameter sequenticalMapping is configured, the first TCI state is applied to the reception of the first and second PDSCH transmission occasions, and the second TCI state is applied to the reception of the third and fourth PDSCH transmission occasions, and the same TCI mapping pattern continues to the remaining PDSCH transmission occasions.

An example of case 153 is illustrated in FIG. 6. Eight (8) PDSCH transmission occasions (shown as “PDSCH #1”, “PDSCH #2”, “PDSCH #3”, “PDSCH #4”, “PDSCH #5”, “PDSCH #6”, “PDSCH #7”, “PDSCH #8” in FIG. 6) are scheduled, respectively, in slots n to n+7. The first TCI state is applied to the reception of the first PDSCH transmission occasion (i.e. “PDSCH #1”) and the second PDSCH transmission occasion (i.e. “PDSCH #2”), and the second TCI state is applied to the reception of the third PDSCH transmission occasion (i.e. “PDSCH #3”) and the fourth PDSCH transmission occasion (i.e. “PDSCH #4”). In addition, the first TCI state is applied to the reception of the fifth PDSCH transmission occasion (i.e. “PDSCH #5”) and the sixth PDSCH transmission occasion (i.e. “PDSCH #6”), and the second TCI state is applied to the reception of the seventh PDSCH transmission occasion (i.e. “PDSCH #7”) and the eighth PDSCH transmission occasion (i.e. “PDSCH #8”).

Case 16: When a UE receives a DCI containing the ‘antenna port(s)’ field indicating (e.g. by antenna port indication table) DMRS ports within two CDM groups (e.g. a first CDM group and a second CDM group), and SFN scheme (SFN scheme A or SFN scheme B) is not configured (that is, the RRC parameter sfnSchemePdsch is not configured) or the RRC parameter repetitionScheme is set to ‘fdmSchemeA’ or ‘fdmSchemeB’ or ‘tdmSchemeA’, the UE shall receive a PDSCH transmission occasion transmitted by SDM scheme 1a. The UE assumes that the DMRS ports within the first CDM group are QCLed with the DL-RSs of the first TCI state, and the DMRS ports within the second CDM group are QCLed with the DL-RSs of the second TCI state.

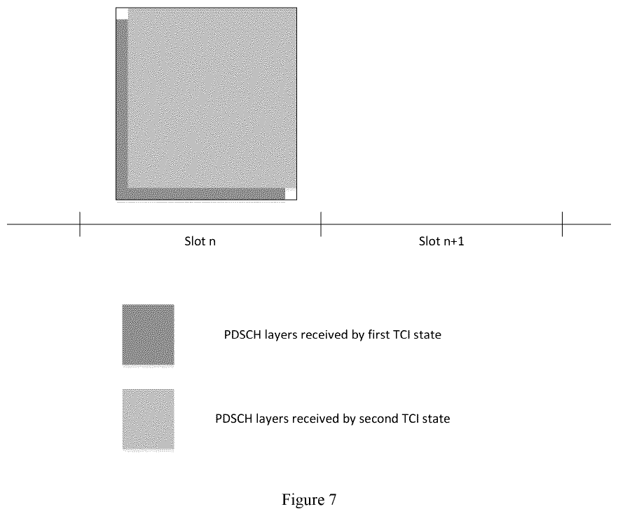

An example of case 16 is illustrated in FIG. 7. A PDSCH transmission is scheduled to be transmitted by two TRPs (e.g. TRP #1 and TRP #2) on a same set of frequency-time resources. Different layers of the PDSCH transmission are transmitted by different TRPs. The PDSCH layers transmitted by TRP #1 are associated with the DMRS ports of the first CDM group, and the PDSCH layers transmitted by TRP #2 are associated with the DMRS ports of the second CDM group. The first TCI state is applied to the reception of the PDSCH layers associated with the DMRS ports of the first CDM group, and the second TCI state is applied to the reception of the PDSCH layers associated with the DMRS ports of the second CDM group.

A second embodiment is related to the determination of TCI state for reception of PDSCH scheduled by DCI carried in PDCCH from a first CORESET that is CORESET #0 or CORESET other than CORESET #0 associated with a search space only in SS category #2 (i.e. CSS other than Type3-PDCCH CSS sets) in a CC, when two DL or joint TCI states (e.g. first TCI state and second TCI state) are indicated for DL reception (e.g. as described in above example, when TCI codepoint 110 is activated, two DL TCI states, e.g., DL-TCI-State #64 and DL-TCI-State #85, are indicated as the DL TCI states: the first TCI state is DL-TCI-State #64 and the second TCI state is DL-TCI-State #85).

Case 21: When a higher layer parameter is configured for the first CORESET to use one of or both the first TCI state and the second TCI state, e.g., a RRC parameter useFirstIndicatedTCIState indicating that the first TCI state is applied, useSecondIndicatedTCIState indicating that the second TCI state is applied, or useIndicatedTCIState indicating that both the first TCI state and the second TCI state are applied, the UE applies the indicated TCI state(s) by the configured higher layer parameter to the reception of PDSCH scheduled by DCI carried in the PDCCH from the first CORESET. For example, if useSecondIndicatedTCIState is configured for the first CORESET, the second TCI state is applied to the reception of PDSCH scheduled by DCI carried in the PDCCH from the first CORESET

Case 22: When the TCI state(s) for the first CORESET is activated by a MAC CE (which is different from the DL or joint TCI state activation/deactivation MAC CE), the UE applies the first TCI state activated by the MAC CE to the reception of PDSCH scheduled by DCI carried in the PDCCH from the first CORESET.

Case 23: When the QCL assumption for the first CORESET is determined by SSB obtained from the latest RACH procedure, the UE applies the determined SSB to the reception of PDSCH scheduled by DCI carried in the PDCCH from the first CORESET.

For Cases 21, 22 and 23, the UE may alternatively always apply the same TCI state or QCL assumption as that used for reception of a PDCCH from the first CORESET to the reception of PDSCH scheduled by DCI carried in the PDCCH from the first CORESET.

A third embodiment is related to the determination of TCI state for reception of PDSCH scheduled by DCI carried in PDCCH from a second CORESET that is CORESET associated with both SS category #1 (USS and/or Type3-PDCCH CSS sets) and SS category #2 (CSS other than Type3-PDCCH CSS sets) in a CC, when two DL or joint TCI states (e.g. first TCI state and second TCI state) are indicated for DL reception (e.g. as described in above example, when TCI codepoint 110 is activated, two DL TCI states, e.g., DL-TCI-State #64 and DL-TCI-State #85, are indicated as the DL TCI states: the first TCI state is DL-TCI-State #64 and the second TCI state is DL-TCI-State #85).

Case 31: When a higher layer parameter is configured for the second CORESET to use one of or both the first TCI state and the second TCI state, e.g., a RRC parameter useFirstIndicatedTCIState indicating that the first TCI state is applied, useSecondIndicatedTCIState indicating that the second TCI state is applied, or useIndicatedTCIState indicating that both the first TCI state and the second TCI state are applied.

Alternative 311: the indicated TCI state(s) by the configured higher layer parameter are applied to the reception of PDSCH scheduled by DCI carried in the PDCCH from the second CORESET.

Alternative 312: the indicated TCI state(s) by the configured higher layer parameter are applied to the reception of PDSCH scheduled by DCI carried in the PDCCH associated with the CSS other than Type3-PDCCH CSS sets from the second CORESET, while the first TCI state is applied to the reception of PDSCH scheduled by DCI carried in the PDCCH associated with the USS and/or Type3-PDCCH CCS sets from the second CORESET.

Case 32: When the TCI state(s) for the second CORESET are activated by a MAC CE (which is different from the DL or joint TCI state activation/deactivation MAC CE).

Alternative 321: the activated TCI state(s) by the MAC CE are applied to the reception of PDSCH scheduled by DCI carried in the PDCCH from the second CORESET.

Alternative 322: the activated TCI state(s) by the MAC CE are applied to the reception of PDSCH scheduled by DCI carried in the PDCCH associated with the CSS other than Type3-PDCCH CSS sets from the second CORESET, while the first TCI state is applied to the reception of PDSCH scheduled by DCI carried in the PDCCH associated with the USS and/or Type3-PDCCH CCS sets from the second CORESET.

Alternative 323: the activated TCI state(s) by the MAC CE are applied to the reception of PDSCH scheduled by DCI carried in the PDCCH associated with the CSS other than Type3-PDCCH CSS sets from the second CORESET, while the activated TCI state (by DL or joint TCI state activation/deactivation MAC CE) with lowest DL-TCI-StateId (e.g. as described in above example, among all activated DL TCI states, DL-TCI-State #2 (mapped to TCI codepoint 100) has the lowest DL-TCI-State-Id) is applied to the reception of PDSCH scheduled by DCI carried in the PDCCH associated with the USS and/or Type3-PDCCH CCS sets from the second CORESET.

For Cases 31 and 32: the UE may alternatively always apply the same TCI state or QCL assumption as that used for reception of a PDCCH from the second CORESET to the reception of PDSCH scheduled by DCI carried in the PDCCH from the second CORESET.

A fourth embodiment is related to the determination of TCI state for reception of PDSCH scheduled by DCI carried in PDCCH from a third CORESET which is a CORESET whose TCI state is activated by a MAC CE or whose QCL assumption is determined by SSB from the latest RACH procedure, when only one DL or joint TCI state (e.g. the indicated TCI state) is indicated for DL reception (e.g. as described in above example, when TCI codepoint 111 is activated, one DL TCI state, e.g. DL-TCI-State #120,is indicated as the DL TCI state: the indicated TCI state is DL-TCI-State #120), a default TCI state can be determined by one of the following alternatives 41 to 44.

Alternative 41: the TCI state activated by the MAC CE for the third CORESET or the QCL assumption determined for the third CORESET is applied to the reception of PDSCH scheduled by DCI carried in the PDCCH from the third CORESET.

Alternative 42: the indicated TCI state is applied to the reception of PDSCH scheduled by DCI carried in the PDCCH from the third CORESET.

Alternative 43: the activated TCI state (by DL or joint TCI state activation/deactivation MAC CE) with lowest DL-TCI-StateId (e.g. as described in above example, among all activated DL TCI states, DL-TCI-State #2 (mapped to TCI codepoint 100) has the lowest DL-TCI-State-Id) is applied to the reception of PDSCH scheduled by DCI carried in the PDCCH from the third CORESET.

Alternative 44: if the third CORESET is associated with both SS category #1 (USS and/or Type3-PDCCH CSS sets) and SS category #2 (CSS other than Type3-PDCCH CSS sets) in a CC, the TCI state activated by the MAC CE for the third CORESET or the QCL assumption determined for the third CORESET is applied to the reception of PDSCH scheduled by DCI carried in the PDCCH associated with CSS other than Type3-PDCCH CSS set from the third CORESET, and the indicated TCI state is applied to the reception of PDSCH scheduled by DCI carried in the PDCCH associated with USS and/or Type3-PDCCH CSS set from the third CORESET.

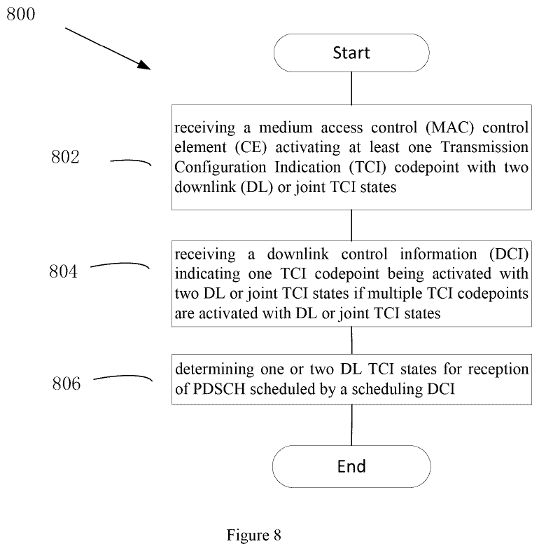

FIG. 8 is a schematic flow chart diagram illustrating an embodiment of a method 800 according to the present application. In some embodiments, the method 800 is performed by an apparatus, such as a remote unit (e.g. UE). In certain embodiments, the method 800 may be performed by a processor executing program code, for example, a microcontroller, a microprocessor, a CPU, a GPU, an auxiliary processing unit, a FPGA, or the like.

The method 800 is a method of a UE, comprising: 802 receiving a medium access control (MAC) control element (CE) activating at least one Transmission Configuration Indication (TCI) codepoint with two downlink (DL) or joint TCI states; 804 receiving a downlink control information (DCI) indicating one TCI codepoint being activated with two DL or joint TCI states if multiple TCI codepoints are activated with DL or joint TCI states; and 806 determining one or two DL TCI states for reception of PDSCH scheduled by a scheduling DCI.

In one embodiment, the method comprises 806 determining, for reception of the scheduled PDSCH, one of or both a first TCI state and a second TCI state of the two DL or joint TCI states activated to the only one activated TCI codepoint or the indicated one TCI codepoint.

In a first implementation, when a higher layer parameter sfnSchemePdsch is set to ‘sfnSchemeA’ or ‘sfnSchemeB’, both the first TCI state and the second TCI state are applied to the reception of the scheduled PDSCH; when a higher layer parameter repetitionScheme is set to ‘fdmSchemeA’ and ‘antenna port(s)’ field in the scheduling DCI indicates DMRS ports within one CDM group, the first TCI state is applied to a first PRB set allocated to the scheduled PDSCH and the second TCI state is applied to a second PRB set allocated to the scheduled PDSCH; when the higher layer parameter repetitionScheme is set to ‘fdmSchemeB’ and ‘antenna port(s)’ field in the scheduling DCI indicates DMRS ports within one CDM group, the first TCI state is applied to a first PRB set allocated to a first scheduled PDSCH transmission occasion and the second TCI state is applied to a second PRB set allocated to the second scheduled PDSCH transmission occasion; when the higher layer parameter repetitionScheme is set to ‘tdmSchemeA’ and ‘antenna port(s)’ field in the scheduling DCI indicates DMRS ports within one CDM group, the first TCI state is applied to a first scheduled PDSCH transmission occasion and the second TCI state is applied to a second scheduled PDSCH transmission occasion; when TDRA field in the scheduling DCI indicates an entry which contains repetitionNumber in PDSCH-TimeDomainResourceAllocation and ‘antenna port(s)’ field in the scheduling DCI indicates DMRS ports within one CDM group, if repetitionNumber=2, the first TCI state is applied to a first PDSCH transmission occasion and the second TCI state is applied to a second PDSCH transmission occasion, if repetitionNumber>2 and cyclicMapping is configured, the first and second TCI states are applied to the first and second PDSCH transmission occasions, respectively, and the same TCI mapping pattern continues to the remaining PDSCH transmission occasions, and if repetitionNumber>2 and sequenticalMapping is configured, the first TCI state is applied to the first and second PDSCH transmission occasions, and the second TCI state is applied to the third and fourth PDSCH transmission occasions, and the same TCI mapping pattern continues to the remaining PDSCH transmission occasions; and when the higher layer parameter sfnSchemePdsch is not configured or the higher layer parameter repetitionScheme is set to ‘fdmSchemeA’ or ‘fdmSchemeB’ or ‘tdmSchemeA’ and ‘antenna port(s)’ field in the scheduling DCI indicates DMRS ports within two CDM groups, the DMRS ports within a first CDM group are QCLed with the DL-RSs of the first TCI state, and the DMRS ports within a second CDM group are QCLed with the DL-RSs of the second TCI state.

In a second implementation, in the condition that one PDSCH is scheduled by the scheduling DCI carried in PDCCH associated with a first CORESET that is CORESET with index 0 or CORESET other than CORESET with index 0 associated with only CSS other than Type3-PDCCH CSS set, the same TCI state or QCL assumption as that used for reception of the PDCCH from the first CORESET is applied to the reception of PDSCH scheduled by the scheduling DCI carried in the PDCCH from the first CORESET, or when a higher layer parameter is configured for the first CORESET to indicate one of or both the first TCI state and the second TCI state, the indicated TCI state(s) by the configured higher layer parameter are applied to the reception of PDSCH scheduled by the scheduling DCI carried in PDCCH from the first CORESET, when the TCI state(s) for the first CORESET is activated by a second MAC CE, the first TCI state activated by the second MAC CE is applied to the reception of PDSCH scheduled by the scheduling DCI carried in the PDCCH from the first CORESET, and when the QCL assumption for the first CORESET is determined by SSB obtained from the latest RACH procedure, the determined SSB is applied to the reception of PDSCH scheduled by the scheduling DCI carried in the PDCCH from the first CORESET.

In a third implementation, in the condition that one PDSCH is scheduled by the scheduling DCI carried in PDCCH associated with a second CORESET that is CORESET associated with both USS and/or Type3-PDCCH CSS sets and CSS other than Type3-PDCCH CSS sets, the same TCI state or QCL assumption as that used for reception of PDCCH from the second CORESET is applied to the reception of PDSCH scheduled by the scheduling DCI carried in the PDCCH from the second CORESET, or when a higher layer parameter is configured for the second CORESET to indicate one of or both the first TCI state and the second TCI state, the TCI state(s) indicated by the configured higher layer parameter are applied to the reception of PDSCH scheduled by the scheduling DCI carried in PDCCH from the second CORESET, or the TCI state(s) indicated by the configured higher layer parameter are applied to the reception of PDSCH scheduled by the scheduling DCI carried in the PDCCH associated with the CSS other than Type3-PDCCH CSS sets from the second CORESET, and the first TCI state is applied to the reception of PDSCH scheduled by the scheduling DCI carried in the PDCCH associated with the USS and/or Type3-PDCCH CCS sets from the second CORESET, and when the TCI state(s) for the second CORESET are activated by a second MAC CE, the TCI state(s) activated by the second MAC CE are applied to the reception of PDSCH scheduled by the scheduling DCI carried in the PDCCH from the second CORESET, or the TCI state(s) activated by the second MAC CE are applied to the reception of PDSCH scheduled by the scheduling DCI carried in the PDCCH associated with the CSS other than Type3-PDCCH CSS sets from the second CORESET, and the first TCI state is applied to the reception of PDSCH scheduled by the scheduling DCI carried in the PDCCH associated with the USS and/or Type3-PDCCH CCS sets from the second CORESET, or the TCI state(s) activated by the second MAC CE are applied to the reception of PDSCH scheduled by the scheduling DCI carried in the PDCCH associated with the CSS other than Type3-PDCCH CSS sets from the second CORESET, and the activated TCI state with the lowest index is applied to the reception of PDSCH scheduled by the scheduling DCI carried in the PDCCH associated with the USS and/or Type3-PDCCH CCS sets from the second CORESET.

In another embodiment, the method comprises 806 determining a default TCI state for the reception of PDSCH scheduled by the scheduling DCI carried in PDCCH from a third CORESET which is a CORESET whose TCI state is activated by a second MAC CE or whose QCL assumption is determined by SSB obtained in the latest RACH procedure, when only one DL TCI state is indicated for DL reception. In particular, the default TCI state is one of: the TCI state activated by the second MAC CE for the third CORESET or the QCL assumption determined for the third CORESET, the indicated one DL TCI state, the activated TCI state with the lowest index, and if the third CORESET is associated with both SS USS and/or Type3-PDCCH CSS sets and CSS other than Type3-PDCCH CSS sets, the TCI state activated by the second MAC CE for the third CORESET or the QCL assumption determined for the third CORESET for the reception of PDSCH scheduled by the scheduling DCI carried in PDCCH associated with CSS other than Type3-PDCCH CSS set from the third CORESET, and the indicated one TCI state for the reception of PDSCH scheduled by the scheduling DCI carried in the PDCCH associated with USS and/or Type3-PDCCH CSS set from the third CORESET.

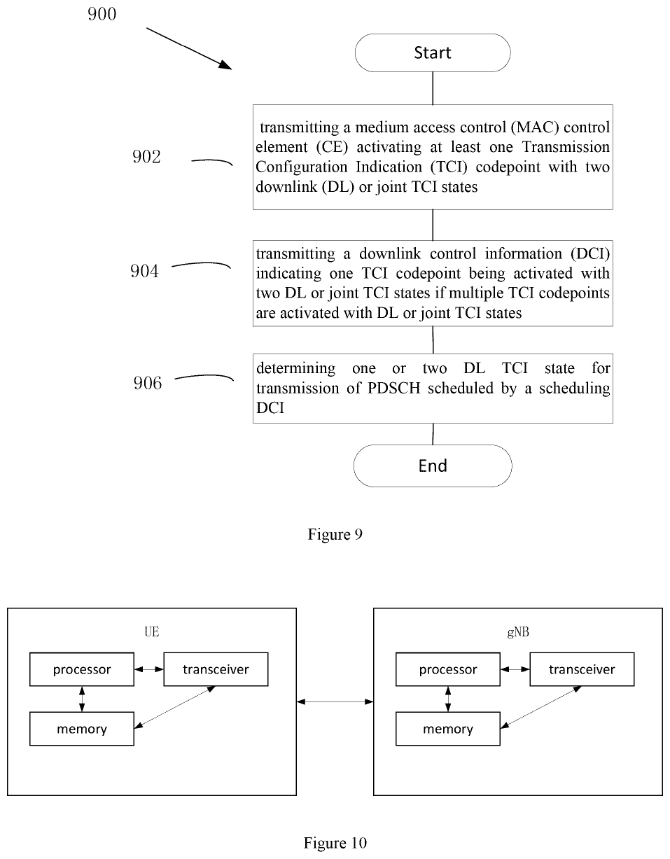

FIG. 9 is a schematic flow chart diagram illustrating an embodiment of a method 900 according to the present application. In some embodiments, the method 900 is performed by an apparatus, such as a base unit. In certain embodiments, the method 900 may be performed by a processor executing program code, for example, a microcontroller, a microprocessor, a CPU, a GPU, an auxiliary processing unit, a FPGA, or the like.

The method 900 may comprise 902 transmitting a medium access control (MAC) control element (CE) activating at least one Transmission Configuration Indication (TCI) codepoint with two downlink (DL) or joint TCI states; 904 transmitting a downlink control information (DCI) indicating one TCI codepoint being activated with two DL or joint TCI states if multiple TCI codepoints are activated with DL or joint TCI states; and 906 determining one or two DL TCI state for transmission of PDSCH scheduled by a scheduling DCI.

In one embodiment, the method comprises 906 determining, for transmission of the scheduled PDSCH, one of or both a first TCI state and a second TCI state of the two DL or joint TCI states activated to the only one activated TCI codepoint or the indicated one TCI codepoint.

In a first implementation, when a higher layer parameter sfnSchemePdsch is set to ‘sfnSchemeA’ or ‘sfnSchemeB’, both the first TCI state and the second TCI state are applied to the transmission of the scheduled PDSCH; when a higher layer parameter repetitionScheme is set to ‘fdmSchemeA’ and ‘antenna port(s)’ field in the scheduling DCI indicates DMRS ports within one CDM group, the first TCI state is applied to a first PRB set allocated to the scheduled PDSCH and the second TCI state is applied to a second PRB set allocated to the scheduled PDSCH; when the higher layer parameter repetitionScheme is set to ‘fdmSchemeB’ and ‘antenna port(s)’ field in the scheduling DCI indicates DMRS ports within one CDM group, the first TCI state is applied to a first PRB set allocated to a first scheduled PDSCH transmission occasion and the second TCI state is applied to a second PRB set allocated to the second scheduled PDSCH transmission occasion; when the higher layer parameter repetitionScheme is set to ‘tdmSchemeA’ and ‘antenna port(s)’ field in the scheduling DCI indicates DMRS ports within one CDM group, the first TCI state is applied to a first scheduled PDSCH transmission occasion and the second TCI state is applied to a second scheduled PDSCH transmission occasion; when TDRA field in the scheduling DCI indicates an entry which contains repetitionNumber in PDSCH-TimeDomainResourceAllocation and ‘antenna port(s)’ field in the scheduling DCI indicates DMRS ports within one CDM group, if repetitionNumber=2, the first TCI state is applied to a first PDSCH transmission occasion and the second TCI state is applied to a second PDSCH transmission occasion, if repetitionNumber>2 and cyclicMapping is configured, the first and second TCI states are applied to the first and second PDSCH transmission occasions, respectively, and the same TCI mapping pattern continues to the remaining PDSCH transmission occasions, and if repetitionNumber>2 and sequenticalMapping is configured, the first TCI state is applied to the first and second PDSCH transmission occasions, and the second TCI state is applied to the third and fourth PDSCH transmission occasions, and the same TCI mapping pattern continues to the remaining PDSCH transmission occasions; and when the higher layer parameter sfnSchemePdsch is not configured or the higher layer parameter repetitionScheme is set to ‘fdmSchemeA’ or ‘fdmSchemeB’ or ‘tdmSchemeA’ and ‘antenna port(s)’ field in the scheduling DCI indicates DMRS ports within two CDM groups, the DMRS ports within a first CDM group are QCLed with the DL-RSs of the first TCI state, and the DMRS ports within a second CDM group are QCLed with the DL-RSs of the second TCI state.

In a second implementation, in the condition that one PDSCH is scheduled by the scheduling DCI carried in PDCCH associated with a first CORESET that is CORESET with index 0 or CORESET other than CORESET with index 0 associated with only CSS other than Type3-PDCCH CSS set, the same TCI state or QCL assumption as that used for transmission of the PDCCH from the first CORESET is applied to the transmission of PDSCH scheduled by the scheduling DCI carried in the PDCCH from the first CORESET, or when a higher layer parameter is configured for the first CORESET to indicate one of or both the first TCI state and the second TCI state, the indicated TCI state(s) by the configured higher layer parameter are applied to the transmission of PDSCH scheduled by the scheduling DCI carried in PDCCH from the first CORESET, when the TCI state(s) for the first CORESET is activated by a second MAC CE, the first TCI state activated by the second MAC CE is applied to the transmission of PDSCH scheduled by the scheduling DCI carried in the PDCCH from the first CORESET, and when the QCL assumption for the first CORESET is determined by SSB obtained from the latest RACH procedure, the determined SSB is applied to the transmission of PDSCH scheduled by the scheduling DCI carried in the PDCCH from the first CORESET.

In a third implementation, in the condition that one PDSCH is scheduled by the scheduling DCI carried in PDCCH associated with a second CORESET that is CORESET associated with both USS and/or Type3-PDCCH CSS sets and CSS other than Type3-PDCCH CSS sets, the same TCI state or QCL assumption as that used for transmission of PDCCH from the second CORESET is applied to the transmission of PDSCH scheduled by the scheduling DCI carried in the PDCCH from the second CORESET, or when a higher layer parameter is configured for the second CORESET to indicate one of or both the first TCI state and the second TCI state, the TCI state(s) indicated by the configured higher layer parameter are applied to the transmission of PDSCH scheduled by the scheduling DCI carried in PDCCH from the second CORESET, or the TCI state(s) indicated by the configured higher layer parameter are applied to the transmission of PDSCH scheduled by the scheduling DCI carried in the PDCCH associated with the CSS other than Type3-PDCCH CSS sets from the second CORESET, and the first TCI state is applied to the transmission of PDSCH scheduled by the scheduling DCI carried in the PDCCH associated with the USS and/or Type3-PDCCH CCS sets from the second CORESET, and when the TCI state(s) for the second CORESET are activated by a second MAC CE, the TCI state(s) activated by the second MAC CE are applied to the transmission of PDSCH scheduled by the scheduling DCI carried in the PDCCH from the second CORESET, or the TCI state(s) activated by the second MAC CE are applied to the transmission of PDSCH scheduled by the scheduling DCI carried in the PDCCH associated with the CSS other than Type3-PDCCH CSS sets from the second CORESET, and the first TCI state is applied to the transmission of PDSCH scheduled by the scheduling DCI carried in the PDCCH associated with the USS and/or Type3-PDCCH CCS sets from the second CORESET, or the TCI state(s) activated by the second MAC CE are applied to the transmission of PDSCH scheduled by the scheduling DCI carried in the PDCCH associated with the CSS other than Type3-PDCCH CSS sets from the second CORESET, and the activated TCI state with the lowest index is applied to the transmission of PDSCH scheduled by the scheduling DCI carried in the PDCCH associated with the USS and/or Type3-PDCCH CCS sets from the second CORESET.

In another embodiment, the method comprises 906 determining a default TCI state for the transmission of PDSCH scheduled by the scheduling DCI carried in PDCCH from a third CORESET which is a CORESET whose TCI state is activated by a second MAC CE or whose QCL assumption is determined by SSB obtained in the latest RACH procedure, when only one DL TCI state is indicated for DL transmission. In particular, the default TCI state is one of: the TCI state activated by the second MAC CE for the third CORESET or the QCL assumption determined for the third CORESET, the indicated one DL TCI state, the activated TCI state with the lowest index, and if the third CORESET is associated with both SS USS and/or Type3-PDCCH CSS sets and CSS other than Type3-PDCCH CSS sets, the TCI state activated by the second MAC CE for the third CORESET or the QCL assumption determined for the third CORESET for the transmission of PDSCH scheduled by the scheduling DCI carried in PDCCH associated with CSS other than Type3-PDCCH CSS set from the third CORESET, and the indicated one TCI state for the transmission of PDSCH scheduled by the scheduling DCI carried in the PDCCH associated with USS and/or Type3-PDCCH CSS set from the third CORESET.

FIG. 10 is a schematic block diagram illustrating apparatuses according to one embodiment.

Referring to FIG. 10, the UE (i.e. the remote unit) includes a processor, a memory, and a transceiver. The processor implements a function, a process, and/or a method which are proposed in FIG. 8.

The UE comprises a transceiver; and a processor coupled to the transceiver, wherein the processor is configured to receive, via the transceiver, a medium access control (MAC) control element (CE) activating at least one Transmission Configuration Indication (TCI) codepoint with two downlink (DL) or joint TCI states; receive, via the transceiver, a downlink control information (DCI) indicating one TCI codepoint being activated with two DL or joint TCI states if multiple TCI codepoints are activated with DL or joint TCI states; and determine one or two DL TCI states for reception of PDSCH scheduled by a scheduling DCI.

In one embodiment, the processor is configured to determine, for reception of the scheduled PDSCH, one of or both a first TCI state and a second TCI state of the two DL or joint TCI states activated to the only one activated TCI codepoint or the indicated one TCI codepoint.

In a first implementation, when a higher layer parameter sfnSchemePdsch is set to ‘sfnSchemeA’ or ‘sfnSchemeB’, both the first TCI state and the second TCI state are applied to the reception of the scheduled PDSCH; when a higher layer parameter repetitionScheme is set to ‘fdmSchemeA’ and ‘antenna port(s)’ field in the scheduling DCI indicates DMRS ports within one CDM group, the first TCI state is applied to a first PRB set allocated to the scheduled PDSCH and the second TCI state is applied to a second PRB set allocated to the scheduled PDSCH; when the higher layer parameter repetitionScheme is set to ‘fdmSchemeB’ and ‘antenna port(s)’ field in the scheduling DCI indicates DMRS ports within one CDM group, the first TCI state is applied to a first PRB set allocated to a first scheduled PDSCH transmission occasion and the second TCI state is applied to a second PRB set allocated to the second scheduled PDSCH transmission occasion; when the higher layer parameter repetitionScheme is set to ‘tdmSchemeA’ and ‘antenna port(s)’ field in the scheduling DCI indicates DMRS ports within one CDM group, the first TCI state is applied to a first scheduled PDSCH transmission occasion and the second TCI state is applied to a second scheduled PDSCH transmission occasion; when TDRA field in the scheduling DCI indicates an entry which contains repetitionNumber in PDSCH-TimeDomainResourceAllocation and ‘antenna port(s)’ field in the scheduling DCI indicates DMRS ports within one CDM group, if repetitionNumber=2, the first TCI state is applied to a first PDSCH transmission occasion and the second TCI state is applied to a second PDSCH transmission occasion, if repetitionNumber>2 and cyclicMapping is configured, the first and second TCI states are applied to the first and second PDSCH transmission occasions, respectively, and the same TCI mapping pattern continues to the remaining PDSCH transmission occasions, and if repetitionNumber>2 and sequenticalMapping is configured, the first TCI state is applied to the first and second PDSCH transmission occasions, and the second TCI state is applied to the third and fourth PDSCH transmission occasions, and the same TCI mapping pattern continues to the remaining PDSCH transmission occasions; and when the higher layer parameter sfnSchemePdsch is not configured or the higher layer parameter repetitionScheme is set to ‘fdmSchemeA’ or ‘fdmSchemeB’ or ‘tdmSchemeA’ and ‘antenna port(s)’ field in the scheduling DCI indicates DMRS ports within two CDM groups, the DMRS ports within a first CDM group are QCLed with the DL-RSs of the first TCI state, and the DMRS ports within a second CDM group are QCLed with the DL-RSs of the second TCI state.

In a second implementation, in the condition that one PDSCH is scheduled by the scheduling DCI carried in PDCCH associated with a first CORESET that is CORESET with index 0 or CORESET other than CORESET with index 0 associated with only CSS other than Type3-PDCCH CSS set, the same TCI state or QCL assumption as that used for reception of the PDCCH from the first CORESET is applied to the reception of PDSCH scheduled by the scheduling DCI carried in the PDCCH from the first CORESET, or when a higher layer parameter is configured for the first CORESET to indicate one of or both the first TCI state and the second TCI state, the indicated TCI state(s) by the configured higher layer parameter are applied to the reception of PDSCH scheduled by the scheduling DCI carried in PDCCH from the first CORESET, when the TCI state(s) for the first CORESET is activated by a second MAC CE, the first TCI state activated by the second MAC CE is applied to the reception of PDSCH scheduled by the scheduling DCI carried in the PDCCH from the first CORESET, and when the QCL assumption for the first CORESET is determined by SSB obtained from the latest RACH procedure, the determined SSB is applied to the reception of PDSCH scheduled by the scheduling DCI carried in the PDCCH from the first CORESET.

In a third implementation, in the condition that one PDSCH is scheduled by the scheduling DCI carried in PDCCH associated with a second CORESET that is CORESET associated with both USS and/or Type3-PDCCH CSS sets and CSS other than Type3-PDCCH CSS sets, the same TCI state or QCL assumption as that used for reception of PDCCH from the second CORESET is applied to the reception of PDSCH scheduled by the scheduling DCI carried in the PDCCH from the second CORESET, or when a higher layer parameter is configured for the second CORESET to indicate one of or both the first TCI state and the second TCI state, the TCI state(s) indicated by the configured higher layer parameter are applied to the reception of PDSCH scheduled by the scheduling DCI carried in PDCCH from the second CORESET, or the TCI state(s) indicated by the configured higher layer parameter are applied to the reception of PDSCH scheduled by the scheduling DCI carried in the PDCCH associated with the CSS other than Type3-PDCCH CSS sets from the second CORESET, and the first TCI state is applied to the reception of PDSCH scheduled by the scheduling DCI carried in the PDCCH associated with the USS and/or Type3-PDCCH CCS sets from the second CORESET, and when the TCI state(s) for the second CORESET are activated by a second MAC CE, the TCI state(s) activated by the second MAC CE are applied to the reception of PDSCH scheduled by the scheduling DCI carried in the PDCCH from the second CORESET, or the TCI state(s) activated by the second MAC CE are applied to the reception of PDSCH scheduled by the scheduling DCI carried in the PDCCH associated with the CSS other than Type3-PDCCH CSS sets from the second CORESET, and the first TCI state is applied to the reception of PDSCH scheduled by the scheduling DCI carried in the PDCCH associated with the USS and/or Type3-PDCCH CCS sets from the second CORESET, or the TCI state(s) activated by the second MAC CE are applied to the reception of PDSCH scheduled by the scheduling DCI carried in the PDCCH associated with the CSS other than Type3-PDCCH CSS sets from the second CORESET, and the activated TCI state with the lowest index is applied to the reception of PDSCH scheduled by the scheduling DCI carried in the PDCCH associated with the USS and/or Type3-PDCCH CCS sets from the second CORESET.

In another embodiment, the processor is configured to determine a default TCI state for the reception of PDSCH scheduled by the scheduling DCI carried in PDCCH from a third CORESET which is a CORESET whose TCI state is activated by a second MAC CE or whose QCL assumption is determined by SSB obtained in the latest RACH procedure, when only one DL TCI state is indicated for DL reception. In particular, the default TCI state is one of: the TCI state activated by the second MAC CE for the third CORESET or the QCL assumption determined for the third CORESET, the indicated one DL TCI state, the activated TCI state with the lowest index, and if the third CORESET is associated with both SS USS and/or Type3-PDCCH CSS sets and CSS other than Type3-PDCCH CSS sets, the TCI state activated by the second MAC CE for the third CORESET or the QCL assumption determined for the third CORESET for the reception of PDSCH scheduled by the scheduling DCI carried in PDCCH associated with CSS other than Type3-PDCCH CSS set from the third CORESET, and the indicated one TCI state for the reception of PDSCH scheduled by the scheduling DCI carried in the PDCCH associated with USS and/or Type3-PDCCH CSS set from the third CORESET.

The gNB (i.e. the base unit) includes a processor, a memory, and a transceiver. The processor implements a function, a process, and/or a method which are proposed in FIG. 9.

The base unit comprises a transceiver; and a processor coupled to the transceiver, wherein the processor is configured to transmit, via the transceiver, a medium access control (MAC) control element (CE) activating at least one Transmission Configuration Indication (TCI) codepoint with two downlink (DL) or joint TCI states; transmit, via the transceiver, a downlink control information (DCI) indicating one TCI codepoint being activated with two DL or joint TCI states if multiple TCI codepoints are activated with DL or joint TCI states; and determine one or two DL TCI state for transmission of PDSCH scheduled by a scheduling DCI.

In one embodiment, the processor is configured to determine, for transmission of the scheduled PDSCH, one of or both a first TCI state and a second TCI state of the two DL or joint TCI states activated to the only one activated TCI codepoint or the indicated one TCI codepoint.

In a first implementation, when a higher layer parameter sfnSchemePdsch is set to ‘sfnSchemeA’ or ‘sfnSchemeB’, both the first TCI state and the second TCI state are applied to the transmission of the scheduled PDSCH; when a higher layer parameter repetitionScheme is set to ‘fdmSchemeA’ and ‘antenna port(s)’ field in the scheduling DCI indicates DMRS ports within one CDM group, the first TCI state is applied to a first PRB set allocated to the scheduled PDSCH and the second TCI state is applied to a second PRB set allocated to the scheduled PDSCH; when the higher layer parameter repetitionScheme is set to ‘fdmSchemeB’ and ‘antenna port(s)’ field in the scheduling DCI indicates DMRS ports within one CDM group, the first TCI state is applied to a first PRB set allocated to a first scheduled PDSCH transmission occasion and the second TCI state is applied to a second PRB set allocated to the second scheduled PDSCH transmission occasion; when the higher layer parameter repetitionScheme is set to ‘tdmSchemeA’ and ‘antenna port(s)’ field in the scheduling DCI indicates DMRS ports within one CDM group, the first TCI state is applied to a first scheduled PDSCH transmission occasion and the second TCI state is applied to a second scheduled PDSCH transmission occasion; when TDRA field in the scheduling DCI indicates an entry which contains repetitionNumber in PDSCH-TimeDomainResourceAllocation and ‘antenna port(s)’ field in the scheduling DCI indicates DMRS ports within one CDM group, if repetitionNumber=2, the first TCI state is applied to a first PDSCH transmission occasion and the second TCI state is applied to a second PDSCH transmission occasion, if repetitionNumber>2 and cyclicMapping is configured, the first and second TCI states are applied to the first and second PDSCH transmission occasions, respectively, and the same TCI mapping pattern continues to the remaining PDSCH transmission occasions, and if repetitionNumber>2 and sequenticalMapping is configured, the first TCI state is applied to the first and second PDSCH transmission occasions, and the second TCI state is applied to the third and fourth PDSCH transmission occasions, and the same TCI mapping pattern continues to the remaining PDSCH transmission occasions; and when the higher layer parameter sfnSchemePdsch is not configured or the higher layer parameter repetitionScheme is set to ‘fdmSchemeA’ or ‘fdmSchemeB’ or ‘tdmSchemeA’ and ‘antenna port(s)’ field in the scheduling DCI indicates DMRS ports within two CDM groups, the DMRS ports within a first CDM group are QCLed with the DL-RSs of the first TCI state, and the DMRS ports within a second CDM group are QCLed with the DL-RSs of the second TCI state.

In a second implementation, in the condition that one PDSCH is scheduled by the scheduling DCI carried in PDCCH associated with a first CORESET that is CORESET with index 0 or CORESET other than CORESET with index 0 associated with only CSS other than Type3-PDCCH CSS set, the same TCI state or QCL assumption as that used for transmission of the PDCCH from the first CORESET is applied to the transmission of PDSCH scheduled by the scheduling DCI carried in the PDCCH from the first CORESET, or when a higher layer parameter is configured for the first CORESET to indicate one of or both the first TCI state and the second TCI state, the indicated TCI state(s) by the configured higher layer parameter are applied to the transmission of PDSCH scheduled by the scheduling DCI carried in PDCCH from the first CORESET, when the TCI state(s) for the first CORESET is activated by a second MAC CE, the first TCI state activated by the second MAC CE is applied to the transmission of PDSCH scheduled by the scheduling DCI carried in the PDCCH from the first CORESET, and when the QCL assumption for the first CORESET is determined by SSB obtained from the latest RACH procedure, the determined SSB is applied to the transmission of PDSCH scheduled by the scheduling DCI carried in the PDCCH from the first CORESET.

In a third implementation, in the condition that one PDSCH is scheduled by the scheduling DCI carried in PDCCH associated with a second CORESET that is CORESET associated with both USS and/or Type3-PDCCH CSS sets and CSS other than Type3-PDCCH CSS sets, the same TCI state or QCL assumption as that used for transmission of PDCCH from the second CORESET is applied to the transmission of PDSCH scheduled by the scheduling DCI carried in the PDCCH from the second CORESET, or when a higher layer parameter is configured for the second CORESET to indicate one of or both the first TCI state and the second TCI state, the TCI state(s) indicated by the configured higher layer parameter are applied to the transmission of PDSCH scheduled by the scheduling DCI carried in PDCCH from the second CORESET, or the TCI state(s) indicated by the configured higher layer parameter are applied to the transmission of PDSCH scheduled by the scheduling DCI carried in the PDCCH associated with the CSS other than Type3-PDCCH CSS sets from the second CORESET, and the first TCI state is applied to the transmission of PDSCH scheduled by the scheduling DCI carried in the PDCCH associated with the USS and/or Type3-PDCCH CCS sets from the second CORESET, and when the TCI state(s) for the second CORESET are activated by a second MAC CE, the TCI state(s) activated by the second MAC CE are applied to the transmission of PDSCH scheduled by the scheduling DCI carried in the PDCCH from the second CORESET, or the TCI state(s) activated by the second MAC CE are applied to the transmission of PDSCH scheduled by the scheduling DCI carried in the PDCCH associated with the CSS other than Type3-PDCCH CSS sets from the second CORESET, and the first TCI state is applied to the transmission of PDSCH scheduled by the scheduling DCI carried in the PDCCH associated with the USS and/or Type3-PDCCH CCS sets from the second CORESET, or the TCI state(s) activated by the second MAC CE are applied to the transmission of PDSCH scheduled by the scheduling DCI carried in the PDCCH associated with the CSS other than Type3-PDCCH CSS sets from the second CORESET, and the activated TCI state with the lowest index is applied to the transmission of PDSCH scheduled by the scheduling DCI carried in the PDCCH associated with the USS and/or Type3-PDCCH CCS sets from the second CORESET.

In another embodiment, the processor is configured to determine a default TCI state for the transmission of PDSCH scheduled by the scheduling DCI carried in PDCCH from a third CORESET which is a CORESET whose TCI state is activated by a second MAC CE or whose QCL assumption is determined by SSB obtained in the latest RACH procedure, when only one DL TCI state is indicated for DL transmission. In particular, the default TCI state is one of: the TCI state activated by the second MAC CE for the third CORESET or the QCL assumption determined for the third CORESET, the indicated one DL TCI state, the activated TCI state with the lowest index, and if the third CORESET is associated with both SS USS and/or Type3-PDCCH CSS sets and CSS other than Type3-PDCCH CSS sets, the TCI state activated by the second MAC CE for the third CORESET or the QCL assumption determined for the third CORESET for the transmission of PDSCH scheduled by the scheduling DCI carried in PDCCH associated with CSS other than Type3-PDCCH CSS set from the third CORESET, and the indicated one TCI state for the transmission of PDSCH scheduled by the scheduling DCI carried in the PDCCH associated with USS and/or Type3-PDCCH CSS set from the third CORESET.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated in the appended claims rather than by the foregoing description. All changes which come within the meaning and range of equivalency of the claims are to be embraced within their scope.

1. A user equipment (UE) for wireless communication, comprising:
at least one memory; and
at least one processor coupled with the at least one memory and configured to cause the UE to:
receive a medium access control (MAC) control element (CE) activating at least one Transmission Configuration Indication (TCI) codepoint with two downlink (DL) or joint TCI states;
receive a downlink control information (DCI) indicating one TCI codepoint being activated with two DL or joint TCI states if multiple TCI codepoints are activated with DL or joint TCI states; and
determine the indicated one DL TCI state for reception of physical downlink shared channel (PDSCH) scheduled by physical downlink control channel (PDCCH) from a control resource set (CORESET) whose TCI state is activated by a second MAC CE or whose quasi co-location (QCL) assumption is determined by a synchronization signal block (SSB) obtained in a latest random access channel (RACH) procedure.

2. The UE of claim 1, wherein, the at least one processor is further configured to cause the UE to: determine, for reception of the scheduled PDSCH, one or both of a first TCI state and a second TCI state of the two DL or joint TCI states activated to the only one activated TCI codepoint or the indicated one TCI codepoint.

3. The UE of claim 2, wherein,
when a higher layer parameter sfnSchemePdsch is set to ‘sfnSchemeA’ or ‘sfnSchemeB’, both the first TCI state and the second TCI state are applied to the reception of the scheduled PDSCH;
when a higher layer parameter repetitionScheme is set to ‘fdmSchemeA’ and ‘antenna port(s)’ field in the scheduling DCI indicates demodulation reference signal (DMRS) ports within one code division multiplexing (CDM) group, the first TCI state is applied to a first physical resource block (PRB) set allocated to the scheduled PDSCH and the second TCI state is applied to a second PRB set allocated to the scheduled PDSCH;
when the higher layer parameter repetitionScheme is set to ‘fdmSchemeB’ and ‘antenna port(s)’ field in the scheduling DCI indicates DMRS ports within one CDM group, the first TCI state is applied to a first PRB set allocated to a first scheduled PDSCH transmission occasion and the second TCI state is applied to a second PRB set allocated to the second scheduled PDSCH transmission occasion;
when the higher layer parameter repetitionScheme is set to ‘tdmSchemeA’ and ‘antenna port(s)’ field in the scheduling DCI indicates DMRS ports within one CDM group, the first TCI state is applied to a first scheduled PDSCH transmission occasion and the second TCI state is applied to a second scheduled PDSCH transmission occasion;
when time-domain resource allocation (TDRA) field in the scheduling DCI indicates an entry which contains repetitionNumber in PDSCH-TimeDomainResourceAllocation and ‘antenna port(s)’ field in the scheduling DCI indicates DMRS ports within one CDM group,
if repetitionNumber=2, the first TCI state is applied to a first PDSCH transmission occasion and the second TCI state is applied to a second PDSCH transmission occasion,
if repetitionNumber>2 and cyclicMapping is configured, the first and second TCI states are applied to the first and second PDSCH transmission occasions, respectively, and the same TCI mapping pattern continues to the remaining PDSCH transmission occasions, and
if repetitionNumber>2 and sequenticalMapping is configured, the first TCI state is applied to the first and second PDSCH transmission occasions, and the second TCI state is applied to the third and fourth PDSCH transmission occasions, and the same TCI mapping pattern continues to the remaining PDSCH transmission occasions; and
when the higher layer parameter sfnSchemePdsch is not configured or the higher layer parameter repetitionScheme is set to ‘fdmSchemeA’ or ‘fdmSchemeB’ or ‘tdmSchemeA’ and ‘antenna port(s)’ field in the scheduling DCI indicates DMRS ports within two CDM groups, the DMRS ports within a first CDM group are QCLed with the DL-RSs of the first TCI state, and the DMRS ports within a second CDM group are QCLed with the DL-RSs of the second TCI state.

4. The UE of claim 2, wherein, in the condition that one PDSCH is scheduled by the scheduling DCI carried in PDCCH associated with a first CORESET that is CORESET with index 0 or CORESET other than CORESET with index 0 associated with only CSS other than Type3-PDCCH common search space (CSS) set,
the same TCI state or QCL assumption as that used for reception of the PDCCH from the first CORESET is applied to the reception of PDSCH scheduled by the scheduling DCI carried in the PDCCH from the first CORESET, or
when a higher layer parameter is configured for the first CORESET to indicate one of or both the first TCI state and the second TCI state, the indicated TCI state(s) by the configured higher layer parameter are applied to the reception of PDSCH scheduled by the scheduling DCI carried in PDCCH from the first CORESET,
when the TCI state(s) for the first CORESET is activated by a second MAC CE, the first TCI state activated by the second MAC CE is applied to the reception of PDSCH scheduled by the scheduling DCI carried in the PDCCH from the first CORESET, and
when the QCL assumption for the first CORESET is determined by SSB obtained from the latest RACH procedure, the determined SSB is applied to the reception of PDSCH scheduled by the scheduling DCI carried in the PDCCH from the first CORESET.

5. The UE of claim 2, wherein, in the condition that one PDSCH is scheduled by the scheduling DCI carried in PDCCH associated with a second CORESET that is CORESET associated with both UE specific search space (USS) and/or Type3-PDCCH common search space (CSS) sets and CSS other than Type3-PDCCH CSS sets,
the same TCI state or QCL assumption as that used for reception of PDCCH from the second CORESET is applied to the reception of PDSCH scheduled by the scheduling DCI carried in the PDCCH from the second CORESET, or
when a higher layer parameter is configured for the second CORESET to indicate one of or both the first TCI state and the second TCI state,
the TCI state(s) indicated by the configured higher layer parameter are applied to the reception of PDSCH scheduled by the scheduling DCI carried in PDCCH from the second CORESET, or
the TCI state(s) indicated by the configured higher layer parameter are applied to the reception of PDSCH scheduled by the scheduling DCI carried in the PDCCH associated with the CSS other than Type3-PDCCH CSS sets from the second CORESET, and the first TCI state is applied to the reception of PDSCH scheduled by the scheduling DCI carried in the PDCCH associated with the USS and/or Type3-PDCCH CCS sets from the second CORESET, and
when the TCI state(s) for the second CORESET are activated by a second MAC CE,
the TCI state(s) activated by the second MAC CE are applied to the reception of PDSCH scheduled by the scheduling DCI carried in the PDCCH from the second CORESET, or
the TCI state(s) activated by the second MAC CE are applied to the reception of PDSCH scheduled by the scheduling DCI carried in the PDCCH associated with the CSS other than Type3-PDCCH CSS sets from the second CORESET, and the first TCI state is applied to the reception of PDSCH scheduled by the scheduling DCI carried in the PDCCH associated with the USS and/or Type3-PDCCH CCS sets from the second CORESET, or
the TCI state(s) activated by the second MAC CE are applied to the reception of PDSCH scheduled by the scheduling DCI carried in the PDCCH associated with the CSS other than Type3-PDCCH CSS sets from the second CORESET, and the activated TCI state with the lowest index is applied to the reception of PDSCH scheduled by the scheduling DCI carried in the PDCCH associated with the USS and/or Type3-PDCCH CCS sets from the second CORESET.

6. (canceled)

7. The UE of claim 1, wherein, the default TCI state is one of:
the TCI state activated by the second MAC CE for the third CORESET or the QCL assumption determined for the third CORESET,
the activated TCI state with the lowest index, and
if the third CORESET is associated with both UE specific search space (USS) and/or Type3-PDCCH common search space (CSS) sets and CSS other than Type3-PDCCH CSS sets, the TCI state activated by the second MAC CE for the third CORESET or the QCL assumption determined for the third CORESET for the reception of PDSCH scheduled by the scheduling DCI carried in PDCCH associated with CSS other than Type3-PDCCH CSS set from the third CORESET, and the indicated one TCI state for the reception of PDSCH scheduled by the scheduling DCI carried in the PDCCH associated with USS and/or Type3-PDCCH CSS set from the third CORESET.

8. A method performed by a user equipment (UE), the method comprising:
receiving a medium access control (MAC) control element (CE) activating at least one Transmission Configuration Indication (TCI) codepoint with two downlink (DL) or joint TCI states;
receiving a downlink control information (DCI) indicating one TCI codepoint being activated with two DL or joint TCI states if multiple TCI codepoints are activated with DL or joint TCI states; and
determining the indicated one DL TCI state for reception of physical downlink shared channel (PDSCH) scheduled by physical downlink control channel (PDCCH) from a control resource set (CORESET) whose TCI state is activated by a second MAC CE or whose quasi co-location (QCL) assumption is determined by a synchronization signal block (SSB) obtained in a latest random access channel (RACH) procedure.

9. A base unit, comprising:
least one memory; and
at least one processor coupled with the at least one memory and configured to cause the base unit to:
transmit a medium access control (MAC) control element (CE) activating at least one Transmission Configuration Indication (TCI) codepoint with two downlink (DL) or joint TCI states;
transmit a downlink control information (DCI) indicating one TCI codepoint being activated with two DL or joint TCI states if multiple TCI codepoints are activated with DL or joint TCI states; and
determine the indicated one DL TCI state for reception of physical downlink shared channel (PDSCH) scheduled by physical downlink control channel (PDCCH) from a control resource set (CORESET) whose TCI state is activated by a second MAC CE or whose quasi co-location (QCL) assumption is determined by a synchronization signal block (SSB) obtained in a latest random access channel (RACH) procedure.

10. The base unit of claim 9, wherein, the at least one processor is configured to cause the base unit to: determine, for transmission of the scheduled PDSCH, one or both of a first TCI state and a second TCI state of the two DL or joint TCI states activated to the only one activated TCI codepoint or the indicated one TCI codepoint.

11. The base unit of claim 10, wherein,
when a higher layer parameter sfnSchemePdsch is set to ‘sfnSchemeA’ or ‘sfnSchemeB’, both the first TCI state and the second TCI state are applied to the transmission of the scheduled PDSCH;
when a higher layer parameter repetitionScheme is set to ‘fdmSchemeA’ and ‘antenna port(s)’ field in the scheduling DCI indicates demodulation reference signal (DMRS) ports within one code division multiplexing (CDM) group, the first TCI state is applied to a first physical resource block (PRB) set allocated to the scheduled PDSCH and the second TCI state is applied to a second PRB set allocated to the scheduled PDSCH;
when the higher layer parameter repetitionScheme is set to ‘fdmSchemeB’ and ‘antenna port(s)’ field in the scheduling DCI indicates DMRS ports within one CDM group, the first TCI state is applied to a first PRB set allocated to a first scheduled PDSCH transmission occasion and the second TCI state is applied to a second PRB set allocated to the second scheduled PDSCH transmission occasion;
when the higher layer parameter repetitionScheme is set to ‘tdmSchemeA’ and ‘antenna port(s)’ field in the scheduling DCI indicates DMRS ports within one CDM group, the first TCI state is applied to a first scheduled PDSCH transmission occasion and the second TCI state is applied to a second scheduled PDSCH transmission occasion;
when a time-domain resource allocation (TDRA) field in the scheduling DCI indicates an entry which contains repetitionNumber in PDSCH-TimeDomainResourceAllocation and ‘antenna port(s)’ field in the scheduling DCI indicates DMRS ports within one CDM group,
if repetitionNumber=2, the first TCI state is applied to a first PDSCH transmission occasion and the second TCI state is applied to a second PDSCH transmission occasion,
if repetitionNumber>2 and cyclicMapping is configured, the first and second TCI states are applied to the first and second PDSCH transmission occasions, respectively, and the same TCI mapping pattern continues to the remaining PDSCH transmission occasions, and
if repetitionNumber>2 and sequenticalMapping is configured, the first TCI state is applied to the first and second PDSCH transmission occasions, and the second TCI state is applied to the third and fourth PDSCH transmission occasions, and the same TCI mapping pattern continues to the remaining PDSCH transmission occasions; and
when the higher layer parameter sfnSchemePdsch is not configured or the higher layer parameter repetitionScheme is set to ‘fdmSchemeA’ or ‘fdmSchemeB’ or ‘tdmSchemeA’ and ‘antenna port(s)’ field in the scheduling DCI indicates DMRS ports within two CDM groups, the DMRS ports within a first CDM group are QCLed with the DL-RSs of the first TCI state, and the DMRS ports within a second CDM group are QCLed with the DL-RSs of the second TCI state.

12. The base unit of claim 10, wherein, in the condition that one PDSCH is scheduled by the scheduling DCI carried in PDCCH associated with a first CORESET that is CORESET with index 0 or CORESET other than CORESET with index 0 associated with only common search space (CSS) other than Type3-PDCCH CSS set,
the same TCI state or QCL assumption as that used for transmission of the PDCCH from the first CORESET is applied to the transmission of PDSCH scheduled by the scheduling DCI carried in the PDCCH from the first CORESET, or
when a higher layer parameter is configured for the first CORESET to indicate one of or both the first TCI state and the second TCI state, the indicated TCI state(s) by the configured higher layer parameter are applied to the transmission of PDSCH scheduled by the scheduling DCI carried in PDCCH from the first CORESET,
when the TCI state(s) for the first CORESET is activated by a second MAC CE, the first TCI state activated by the second MAC CE is applied to the transmission of PDSCH scheduled by the scheduling DCI carried in the PDCCH from the first CORESET, and
when the QCL assumption for the first CORESET is determined by synchronization signal block (SSB) obtained from the latest RACH procedure, the determined SSB is applied to the transmission of PDSCH scheduled by the scheduling DCI carried in the PDCCH from the first CORESET.

13. The base unit of claim 10, wherein, in the condition that one PDSCH is scheduled by the scheduling DCI carried in PDCCH associated with a second CORESET that is CORESET associated with both UE specific search space (USS) and/or Type3-PDCCH common search space (CSS) sets and CSS other than Type3-PDCCH CSS sets,
the same TCI state or QCL assumption as that used for transmission of PDCCH from the second CORESET is applied to the transmission of PDSCH scheduled by the scheduling DCI carried in the PDCCH from the second CORESET, or
when a higher layer parameter is configured for the second CORESET to indicate one of or both the first TCI state and the second TCI state,
the TCI state(s) indicated by the configured higher layer parameter are applied to the transmission of PDSCH scheduled by the scheduling DCI carried in PDCCH from the second CORESET, or
the TCI state(s) indicated by the configured higher layer parameter are applied to the transmission of PDSCH scheduled by the scheduling DCI carried in the PDCCH associated with the CSS other than Type3-PDCCH CSS sets from the second CORESET, and the first TCI state is applied to the transmission of PDSCH scheduled by the scheduling DCI carried in the PDCCH associated with the USS and/or Type3-PDCCH CCS sets from the second CORESET, and
when the TCI state(s) for the second CORESET are activated by a second MAC CE,
the TCI state(s) activated by the second MAC CE are applied to the transmission of PDSCH scheduled by the scheduling DCI carried in the PDCCH from the second CORESET, or
the TCI state(s) activated by the second MAC CE are applied to the transmission of PDSCH scheduled by the scheduling DCI carried in the PDCCH associated with the CSS other than Type3-PDCCH CSS sets from the second CORESET, and the first TCI state is applied to the transmission of PDSCH scheduled by the scheduling DCI carried in the PDCCH associated with the USS and/or Type3-PDCCH CCS sets from the second CORESET, or
the TCI state(s) activated by the second MAC CE are applied to the transmission of PDSCH scheduled by the scheduling DCI carried in the PDCCH associated with the CSS other than Type3-PDCCH CSS sets from the second CORESET, and the activated TCI state with the lowest index is applied to the transmission of PDSCH scheduled by the scheduling DCI carried in the PDCCH associated with the USS and/or Type3-PDCCH CCS sets from the second CORESET.

14. (canceled)

15. The base unit of claim 10, wherein, the default TCI state is one of:
the TCI state activated by the second MAC CE for the third CORESET or the QCL assumption determined for the third CORESET,
the activated TCI state with the lowest index, and
if the third CORESET is associated with both UE specific search space (USS) and/or Type3-PDCCH common search space (CSS) sets and CSS other than Type3-PDCCH CSS sets, the TCI state activated by the second MAC CE for the third CORESET or the QCL assumption determined for the third CORESET for the transmission of PDSCH scheduled by the scheduling DCI carried in PDCCH associated with CSS other than Type3-PDCCH CSS set from the third CORESET, and the indicated one TCI state for the transmission of PDSCH scheduled by the scheduling DCI carried in the PDCCH associated with USS and/or Type3-PDCCH CSS set from the third CORESET.

16. A processor for wireless communication, comprising:
at least one controller coupled with at least one memory and configured to cause the processor to:
receive a medium access control (MAC) control element (CE) activating at least one Transmission Configuration Indication (TCI) codepoint with two downlink (DL) or joint TCI states;
receive a downlink control information (DCI) indicating one TCI codepoint being activated with two DL or joint TCI states if multiple TCI codepoints are activated with DL or joint TCI states; and
determine the indicated one DL TCI state for reception of physical downlink shared channel (PDSCH) scheduled by physical downlink control channel (PDCCH) from a control resource set (CORESET) whose TCI state is activated by a second MAC CE or whose quasi co-location (QCL) assumption is determined by a synchronization signal block (SSB) obtained in a latest random access channel (RACH) procedure.

17. The processor of claim 16, wherein the at least one controller is further configured to cause the processor to: determine, for reception of the scheduled PDSCH, one or both of a first TCI state and a second TCI state of the two DL or joint TCI states activated to the only one activated TCI codepoint or the indicated one TCI codepoint.

18. The processor of claim 17, wherein,
when a higher layer parameter sfnSchemePdsch is set to ‘sfnSchemeA’ or ‘sfnSchemeB’, both the first TCI state and the second TCI state are applied to the reception of the scheduled PDSCH;
when a higher layer parameter repetitionScheme is set to ‘fdmSchemeA’ and ‘antenna port(s)’ field in the scheduling DCI indicates demodulation reference signal (DMRS) ports within one code division multiplexing (CDM) group, the first TCI state is applied to a first physical resource block (PRB) set allocated to the scheduled PDSCH and the second TCI state is applied to a second PRB set allocated to the scheduled PDSCH;
when the higher layer parameter repetitionScheme is set to ‘fdmSchemeB’ and ‘antenna port(s)’ field in the scheduling DCI indicates DMRS ports within one CDM group, the first TCI state is applied to a first PRB set allocated to a first scheduled PDSCH transmission occasion and the second TCI state is applied to a second PRB set allocated to the second scheduled PDSCH transmission occasion;
when the higher layer parameter repetitionScheme is set to ‘tdmSchemeA’ and ‘antenna port(s)’ field in the scheduling DCI indicates DMRS ports within one CDM group, the first TCI state is applied to a first scheduled PDSCH transmission occasion and the second TCI state is applied to a second scheduled PDSCH transmission occasion;
when time-domain resource allocation (TDRA) field in the scheduling DCI indicates an entry which contains repetitionNumber in PDSCH-TimeDomainResourceAllocation and ‘antenna port(s)’ field in the scheduling DCI indicates DMRS ports within one CDM group,
if repetitionNumber=2, the first TCI state is applied to a first PDSCH transmission occasion and the second TCI state is applied to a second PDSCH transmission occasion,
if repetitionNumber>2 and cyclicMapping is configured, the first and second TCI states are applied to the first and second PDSCH transmission occasions, respectively, and the same TCI mapping pattern continues to the remaining PDSCH transmission occasions, and
if repetitionNumber>2 and sequenticalMapping is configured, the first TCI state is applied to the first and second PDSCH transmission occasions, and the second TCI state is applied to the third and fourth PDSCH transmission occasions, and the same TCI mapping pattern continues to the remaining PDSCH transmission occasions; and
when the higher layer parameter sfnSchemePdsch is not configured or the higher layer parameter repetitionScheme is set to ‘fdmSchemeA’ or ‘fdmSchemeB’ or ‘tdmSchemeA’ and ‘antenna port(s)’ field in the scheduling DCI indicates DMRS ports within two CDM groups, the DMRS ports within a first CDM group are QCLed with the DL-RSs of the first TCI state, and the DMRS ports within a second CDM group are QCLed with the DL-RSs of the second TCI state.

19. The processor of claim 17, wherein in the condition that one PDSCH is scheduled by the scheduling DCI carried in PDCCH associated with a first CORESET that is CORESET with index 0 or CORESET other than CORESET with index 0 associated with only CSS other than Type3-PDCCH common search space (CSS) set,
the same TCI state or QCL assumption as that used for reception of the PDCCH from the first CORESET is applied to the reception of PDSCH scheduled by the scheduling DCI carried in the PDCCH from the first CORESET, or
when a higher layer parameter is configured for the first CORESET to indicate one of or both the first TCI state and the second TCI state, the indicated TCI state(s) by the configured higher layer parameter are applied to the reception of PDSCH scheduled by the scheduling DCI carried in PDCCH from the first CORESET,
when the TCI state(s) for the first CORESET is activated by a second MAC CE, the first TCI state activated by the second MAC CE is applied to the reception of PDSCH scheduled by the scheduling DCI carried in the PDCCH from the first CORESET, and
when the QCL assumption for the first CORESET is determined by SSB obtained from the latest RACH procedure, the determined SSB is applied to the reception of PDSCH scheduled by the scheduling DCI carried in the PDCCH from the first CORESET.

20. The processor of claim 17, wherein, in the condition that one PDSCH is scheduled by the scheduling DCI carried in PDCCH associated with a second CORESET that is CORESET associated with both UE specific search space (USS) and/or Type3-PDCCH common search space (CSS) sets and CSS other than Type3-PDCCH CSS sets,
the same TCI state or QCL assumption as that used for reception of PDCCH from the second CORESET is applied to the reception of PDSCH scheduled by the scheduling DCI carried in the PDCCH from the second CORESET, or
when a higher layer parameter is configured for the second CORESET to indicate one of or both the first TCI state and the second TCI state,
the TCI state(s) indicated by the configured higher layer parameter are applied to the reception of PDSCH scheduled by the scheduling DCI carried in PDCCH from the second CORESET, or
the TCI state(s) indicated by the configured higher layer parameter are applied to the reception of PDSCH scheduled by the scheduling DCI carried in the PDCCH associated with the CSS other than Type3-PDCCH CSS sets from the second CORESET, and the first TCI state is applied to the reception of PDSCH scheduled by the scheduling DCI carried in the PDCCH associated with the USS and/or Type3-PDCCH CCS sets from the second CORESET, and
when the TCI state(s) for the second CORESET are activated by a second MAC CE,
the TCI state(s) activated by the second MAC CE are applied to the reception of PDSCH scheduled by the scheduling DCI carried in the PDCCH from the second CORESET, or
the TCI state(s) activated by the second MAC CE are applied to the reception of PDSCH scheduled by the scheduling DCI carried in the PDCCH associated with the CSS other than Type3-PDCCH CSS sets from the second CORESET, and the first TCI state is applied to the reception of PDSCH scheduled by the scheduling DCI carried in the PDCCH associated with the USS and/or Type3-PDCCH CCS sets from the second CORESET, or
the TCI state(s) activated by the second MAC CE are applied to the reception of PDSCH scheduled by the scheduling DCI carried in the PDCCH associated with the CSS other than Type3-PDCCH CSS sets from the second CORESET, and the activated TCI state with the lowest index is applied to the reception of PDSCH scheduled by the scheduling DCI carried in the PDCCH associated with the USS and/or Type3-PDCCH CCS sets from the second CORESET.

21. The processor of claim 16, wherein, the default TCI state is one of:
the TCI state activated by the second MAC CE for the third CORESET or the QCL assumption determined for the third CORESET,
the activated TCI state with the lowest index, and
if the third CORESET is associated with both UE specific search space (USS) and/or Type3-PDCCH common search space (CSS) sets and CSS other than Type3-PDCCH CSS sets, the TCI state activated by the second MAC CE for the third CORESET or the QCL assumption determined for the third CORESET for the reception of PDSCH scheduled by the scheduling DCI carried in PDCCH associated with CSS other than Type3-PDCCH CSS set from the third CORESET, and the indicated one TCI state for the reception of PDSCH scheduled by the scheduling DCI carried in the PDCCH associated with USS and/or Type3-PDCCH CSS set from the third CORESET.
